(19) United States
(12) Patent Application Publication
(10) Pub. No.: US 2026/0077221 A1
(43) Pub. Date: Mar. 19, 2026

(54) Aerial Firefighting Installations

(71) Applicant: Fire & Flood Emergency Services Ltd., Red Deer (CA)

(72) Inventor: Terry RAYMOND, Red Deer (CA)

(73) Assignee: Fire & Flood Emergency Services Ltd., Red Deer, AB (CA)

(21) Appl. No.: 19/392,958

(22) Filed: Nov. 18, 2025

Related U.S. Application Data
(63) Continuation of application No. PCT/CA2024/050686, filed on May 23, 2024.
(60) Provisional application No. 63/468,587, filed on May 24, 2023.

(51) Int. Cl. A62C 3/02

(52) U.S. Cl. CPC A62C 3/0235

(57) ABSTRACT

A mobile firefighting installation for firefighting helicopter bucket filling operations is provided. The installation includes a container with a vessel having an upper opening extending across a portion of the upper surface and one or more conduits extending from a water source. The conduits are configured to transfer water to the one or more containers via a port in the container or, in the absence of the ports, via the open or openable tops. Also provided is a container configured for use in firefighting helicopter bucket filling operations. The container includes a vessel having a flat upper surface and an upper opening extending across a majority portion of the upper surface.

### CROSS-REFERENCE TO RELATED APPLICATIONS

This application is a continuation of International Patent Application PCT/CA2024/050686, filed May 23, 2024, title “Aerial Firefighting Installations”, and claims the benefit of priority to U.S. Provisional Ser. No. 63/468,587, filed May 24, 2023, both of which are incorporated herein by reference in their entirety.

### TECHNICAL FIELD

The invention relates to firefighting technologies and more particularly to firefighting installations involving dropping water from a bucket carried by a helicopter.

### BACKGROUND OF THE INVENTION

Aerial firefighting includes the use of aircraft and other aerial resources to combat wildfires. The types of aircraft used include fixed-wing aircraft and helicopters. If helicopters are used, they will typically carry buckets suspended from cables. The buckets are typically filled at bodies of water which are suitable for such operations. In situations where a suitable body of water is inconveniently far from the firefighting operations, portable containers may be deployed and filled with water transported to the firefighting staging area using a tank transported by a suitable vehicle.

Examples of such buckets and portable containers suitable for such operations are manufactured by SEI Industries (Delta, BC, Canada) and include the Bambi Bucket® which is designed to transport water by helicopter and the Fireflex Pumpkin Tank™ which is used as a portable water reservoir.

Additional equipment used in aerial firefighting processes is described in U.S. Pat. Nos. 7,387,316, 5,232,246, 5,899,111, 6,158,521, 6,509,844, 7,188,747, 8,978,703, US Patent Application Publication No. WO 2004/0244996, and PCT Patent Application Publication Nos. WO 2008/111864, and WO 2017/031520, each of which is incorporated herein by reference in its entirety.

There remains a need for improvements in processes and equipment for aerial firefighting, particularly processes which involve the use of helicopters.

### SUMMARY OF THE INVENTION

According to one aspect, there is provided a mobile container configured for use in firefighting helicopter bucket filling operations. The container includes a rectangular vessel having a flat upper surface and a rectangular upper opening extending across a majority portion of the upper surface. The opening may be spaced apart from front and back ends of the vessel. The vessel may include front-and back-end barriers extending from front and back edges of the opening towards an interior bottom surface of the vessel. The barriers are configured to permit passage of water to the front and back ends of the vessel while preventing the bucket from moving into front and back interior areas of the vessel when the bucket is dropped into the container via the opening.

In some embodiments, the upper opening extends across no more than about 75% of the upper surface.

In some embodiments, the container may include at least two opposed panels angled upward and outward from edges of the upper opening for guiding the bucket into the upper opening.

In some embodiments, the vessel may have a length of about 36 feet (about 11.0 m) to about 40 feet (about 12.2 m) and a width of about 8.5 feet (about 2.6 m). The upper opening may be substantially centralized with respect to the upper surface with a length of about 24 feet (about 7.3 m) to about 27 m (about 8.2 m) and a width of about 6 feet (about 1.8 m) to about 7 feet (about 2.1 m).

In some embodiments of the container, the opposed panels are pivotably attached to opposed longitudinal edges of the upper opening to function as covers for the upper opening when the container is not actively used in firefighting helicopter bucket filling operations. Each panel of the at least two opposed panels may be dimensioned to cover the upper opening.

In some embodiments, extension of each panel of the set of opposed panels is limited by a stop fixed to the upper surface adjacent to the upper opening. The stop may be configured to retain each panel in a deployed functional position at an angle between about 110° to about 130° with respect to the upper surface of the vessel, thereby providing a funnel shape to guide the bucket into the upper opening.

In some embodiments, the container also includes a panel retention mechanism to retain the opposed panels in the open position.

In some embodiments the container includes front- and back-end barriers extending between the upper surface and an interior bottom surface of the vessel, which are configured to permit passage of water while preventing the bucket from extending into front and back interior areas of the vessel when the bucket is dropped into the container via the opening.

In some embodiments, the vessel includes a port having a diameter of at least about 8 inches (about 20 cm), which is configured for attachment of a water transfer conduit having a diameter of at least about 8 inches (about 20 cm). The container may be retrofitted from a liquid storage tank including a manway with the manway being modified to function as the port.

In some embodiments, the vessel is mounted on a frame with a wheel and axle set and a mechanism for connecting the container to a tow vehicle.

According to another aspect, there is provided a firefighting installation for firefighting helicopter bucket filling operations. The installation includes a container with a vessel having an upper opening extending across a portion of the upper surface, and a conduit extending from a water source. The conduit may be configured to transfer water to the container via a port in the container or, in the absence of the port, via the upper opening.

The firefighting installation may include any of the container embodiments described above.

In some embodiments, the installation includes a water level sensor located inside the vessel, for sensing a specified water level sufficient for a helicopter bucket-filling operation to proceed. The sensor is configured to provide a signal to the helicopter that either the specified water level has been reached and the bucket-filling operation may proceed, or that the water level has not been reached and the bucket-filling operation may not proceed. The installation may also include a transmitter in communication with a conduit valve for closing the conduit and preventing water flow into the vessel when the specified water level has been reached.

The installation may further include an adapter connected to the conduit. The adapter may include a plurality of branch point connectors for splitting the conduit into a network of conduits for optionally filling additional containers optionally included in the installation.

In some embodiments, the plurality of branch point connectors may be six to eight lateral branch point connectors.

In some embodiments, the adapter includes an upper connector for mounting a water dispenser to provide a dampened area at the installation for dust control.

In some embodiments, the flow of water to the water dispenser is automatically stopped as a safety feature when the helicopter reaches a threshold distance to the installation by a receiver sensing the presence of the helicopter, causing a controller to stop the flow of water to the water dispenser. The flow of water may be stopped by the controller shutting a valve in the conduit or shutting off a pump controlling the flow of water.

In some embodiments, the flow of water to the containers is stopped as a safety feature when the helicopter reaches a threshold distance to the installation by a receiver sensing the presence of the helicopter, causing a controller to stop the flow of water to the containers. The flow of water may be stopped by the controller shutting a valve in the conduit or shutting off a pump controlling the flow of water.

In some embodiments, the installation further includes a first extension of the conduit to provide water to one or more additional mobile aerial firefighting installations.

In some embodiments, the installation further includes a second extension of the conduit to one or more ground-based fire suppression lines including a plurality of adapters, each having an irrigation gun mounted thereto.

In some embodiments, the installation further includes a series of in-line pumps in the second extension of the conduit for maintaining water pressure of at least about 80 psi (about 550 kPa) at each adapter of the plurality of adapters.

In some embodiments, each adapter of the plurality of adapters of the ground-based fire suppression system includes six to eight lateral branch point connectors.

In some embodiments, the installation further includes a series of in-line pumps in the conduit for maintaining water pressure at the containers of at least about 80 psi (about 550 kPa).

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. It is emphasized that, in accordance with the standard practice in the industry, various features are not drawn to scale. In fact, the dimensions of the various features may be arbitrarily increased or reduced for clarity of discussion. The drawings are only for purposes of illustrating preferred embodiments and are not to be construed as limiting the disclosure.

FIG. 1 is an illustration of a conventional firefighting system using a dip tank 1 for holding water as a reservoir for a bucket 2 connected to a cable 3 carried by a helicopter 4, in accordance with an aspect of the present disclosure;

FIG. 2 is an illustration of one embodiment of an aerial firefighting system 100 using a shipping container 110 carried by a mobile platform 104 as a reservoir for a bucket 114 connected to a cable 116 carried by a helicopter 112. The shipping container 110 includes a lower port 106 connected to a conduit 108 which is used for transfer of water into the container 110, in accordance with an aspect of the present disclosure;

FIG. 3A is an illustration of a first configuration of a signaling feature embodiment associated with the container 110 to inform a helicopter pilot if the container 110 has at least sufficient water to fill the bucket 114. The signaling includes a sensor and transmitter 118 which senses a threshold water level in the container 110 and sends a signal to a valve 122 in the conduit 108 to close the valve 122 and prevent flow of water into the container 110. A signal 120 informs the helicopter pilot that the bucket can be filled in the present state, in accordance with an aspect of the present disclosure;

FIG. 3B is an illustration of a second state of the signaling feature embodiment of FIG. 3A. In this second state, the water level has dropped below the sensor and transmitter 118, triggering the valve 122 in the conduit 108 to open and permit water to enter the container 110 and raise the water level. The signal 120 informs the helicopter pilot that the bucket cannot be filled in the present state, in accordance with an aspect of the present disclosure;

FIG. 4 is an illustration of one embodiment of a system for transporting four containers 110A to 110D, each representing a standard 10-foot shipping container having dimensions of about 3.0 m (L)×about 2.4 m (W)×about 2.6 m (H), in accordance with an aspect of the present disclosure;

FIG. 5 is an illustration of another embodiment of a system for transporting a single standard 40-foot shipping container 210 having dimensions of about 12.0 m (L)×about 2.4 m (W)×about 2.9 m (H). The container 210 includes three internal dividers 211A-C, which divide the interior volume of the container 210 into four compartments 213A-D, in accordance with an aspect of the present disclosure;

FIG. 6 is an illustration of an aerial firefighting installation including a trailer 125 (towing vehicle disengaged) supporting four containers 110A-D, each receiving water from a corresponding conduit of a series of conduits 108A-D which connect to an adapter 126 receiving water pumped from a water source. The adapter includes a sprinkler 128 to automatically dispense water at the installation to prevent excessive dust from spreading around the installation when the helicopter 112 is hovering above the installation, in accordance with an aspect of the present disclosure;

FIG. 7 is a scheme illustrating installation of a conduit hanger 140 on a top edge 107 of a container wall 111 to support placement of a conduit 108 for filling the container with water, in accordance with an aspect of the present disclosure;

FIG. 8A is a top view of an expanded version of the installation shown in FIG. 6, which illustrates additional features, including three adapters 126A-C and conduits 134, 136, a receiver 132 and controller 130 for automatically controlling the function of a valve 138 and pump 140, in accordance with an aspect of the present disclosure;

FIG. 8B shows a second state of the top view of the installation shown in FIG. 8A, representing a safety feature for the helicopter 112. In this state, the close approach of the helicopter 112 sends a wireless signal (dashed-dot line) to the receiver 132 of the controller 130, which closes the valve 138 and stops the pump 140. This stops the flow of water to all of the conduits 108A-D, 134 and 236 and the sprinklers 126A-C, in accordance with an aspect of the present disclosure;

FIG. 9A is a side elevation view of one embodiment of an adapter 300 used to provide a plurality of branching water service lines, in accordance with an aspect of the present disclosure;

FIG. 9B is a top view of the adapter embodiment 300.

FIG. 9C is an end elevation view of the adapter embodiment 300.

FIG. 10A is an exploded view of another adapter embodiment 500 which includes an upper pipe 531 configured for connecting an irrigation gun 700, in accordance with an aspect of the present disclosure;

FIG. 10B is a side elevation view of the adapter embodiment 500 connected to the irrigation gun 700, in accordance with an aspect of the present disclosure;

FIG. 10C is a top view of the adapter embodiment 500 connected to the irrigation gun 700, in accordance with an aspect of the present disclosure;

FIG. 10D is an end elevation view of the adapter embodiment 500 connected to the irrigation gun 700, in accordance with an aspect of the present disclosure;

FIG. 11 is a perspective view of another container embodiment 810, in accordance with an aspect of the present disclosure;

FIG. 12 is a perspective view of container 810 illustrating deployed bucket guides 813a,b, in accordance with an aspect of the present disclosure;

FIG. 13 is a front-end view of container 810 indicating how a bucket 114 carried on a cable 116 by a helicopter 112 will be guided into the container 810 by deployed bucket guides 813a,b of the container 810, in accordance with an aspect of the present disclosure;

FIG. 14 is a top view of container 810 showing the arrangement of the top opening 816 exposing the interior of the container 810, in accordance with an aspect of the present disclosure;

FIG. 15 is a top view of the container 810 with the bucket guides 813a,b in the open horizontal position showing the opening 816, exposing the interior of the container 810, in accordance with an aspect of the present disclosure;

FIG. 16 is a top view of the container 810 in the arrangement shown in FIG. 15 with curved arrows a and b showing the sequence of closing bucket guide 813b first to cover the opening 816, followed by closing bucket guide 813a on top of bucket guide 813b, in accordance with an aspect of the present disclosure;

FIG. 17 is a top view of the container 810 with both bucket guides 813a,b closed. Bucket guide 813b is not visible because it is covered by bucket guide 813a, in accordance with an aspect of the present disclosure;

FIG. 18 is an upper perspective view of the front of the container 810 indicating a barrier 819 arranged to extend vertically downward from the front end of the opening 816. The barrier 819 permits flow of water to the front section of the container 810 past the opening 816 but blocks a bucket carried by a helicopter (not shown) from moving into the front section, where it could become trapped, in accordance with an aspect of the present disclosure;

FIG. 19A is a top view of an installation using container embodiment 810, which includes three adapters 126A-C and conduits 805, 808 134, 136, a receiver 132 and controller 130 for automatically controlling the function of a valve 138 and pump 140, in accordance with an aspect of the present disclosure;

FIG. 19B shows a second state of the top view of the installation shown in FIG. 19A, representing a safety feature for the helicopter 112. In this state, the close approach of the helicopter 112 sends a wireless signal (dashed-dot line) to the receiver 132 of the controller 130, which closes the valve 138 and stops the pump 140. This stops the flow of water to all conduits 805, 808, 134 and 236 and the sprinklers 128A-C.

FIG. 20A is a map of an area at the main southeast boundary highway entrance to Banff National Park showing an example of provision of a water transfer and staging area in two separated cleared areas in the vicinity of a hypothetical fire on a mountain slope close to a residential area. Inset 20B of FIG. 20A is enlarged in FIG. 20B, in accordance with an aspect of the present disclosure;

FIG. 20B is an enlarged view of the water transfer and staging area shown in the inset of FIG. 20A, highlighting the pathway of a main water transfer conduit extending to four separate aerial firefighting installations, in accordance with an aspect of the present disclosure; and

FIG. 21 is the same map area included in FIG. 20A, showing an extension of the water transfer and staging area to a ground-based fire suppression system including a series of adapters 500 with mounted irrigation guns 700 directing humidity towards the fire area and protecting the residential area in the lower right corner, in accordance with an aspect of the present disclosure.

### DETAILED DESCRIPTION FOR CARRYING OUT THE INVENTION

### Rationale

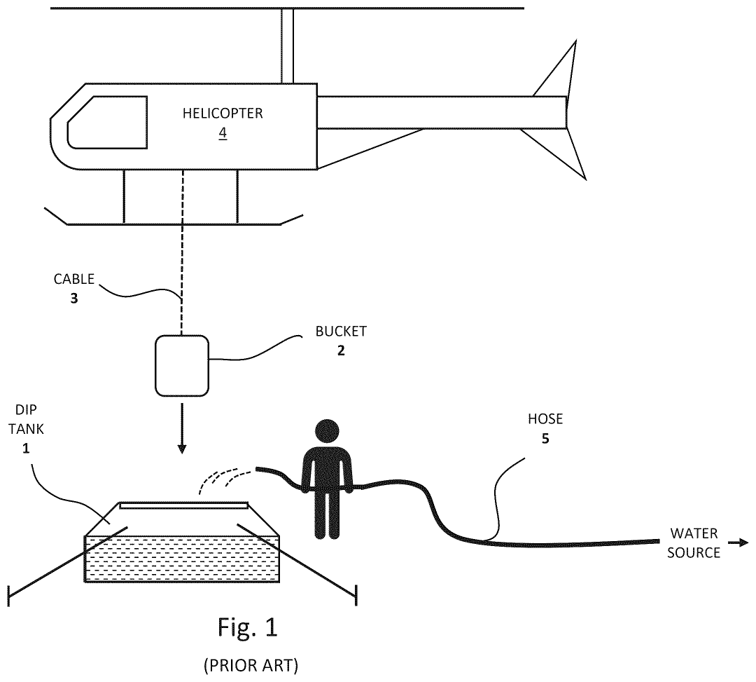

Helicopters are effective in remote firefighting efforts involving dumping water and fire retardant from suspended buckets but are very expensive to operate, particularly when a suitable water source is far from the fire and the helicopter must travel a significant distance to fill the bucket. To date, conventional methods for addressing this distance problem have been to use portable reservoirs known as “dip tanks” which can be deployed at a staging area closer to the site of the firefighting efforts. Such dip tanks usually provide limited volumes of water and either require significant assembly time or are constructed of flexible fabric which is prone to being dislocated by the wind forces of the helicopter rotor downwash. An example of such a conventional arrangement is shown in FIG. 1 illustrating a dip tank 1, being filled with a conventional fire hose 5 for filling a bucket 2 suspended by a cable 3 connected to a helicopter 4. A tie-down arrangement is required for the dip tank 1 to prevent it from being dislodged from the rotor downwash of the helicopter 4. Such tie-down arrangements fail occasionally and disrupt firefighting efforts, leading to costly delays and loss of natural resources and various assets to wildfires.

The technology described herein is expected to provide approximately 250% cost savings for helicopter use by staging sufficient volumes of water closer to the fire suppression areas so that less flying time to and from a water source is required. The firefighting installations and related devices use a mass water transfer system to fill a plurality of mobile tanks such as shipping containers (also colloquially known as “sea cans”) which are carried on mobile platforms such as flatbed trailers to a suitable staging site as close to the fire as possible. Alternatively, mobile tanks developed for oilfield hydraulic fracturing operations, which are known as “frac tanks” may also be used if they are retrofitted to provide certain features described herein. Additionally, containers specifically manufactured to have the features described herein may also be used. The containers may be modified to have filling ports and open or openable tops through which helicopters can fill buckets for firefighting and fire suppression or in the absence of filling ports, a conduit hanger may be used to support the placement of a conduit over the top of a container wall. The open tops of the containers may be provided with helicopter bucket guides to facilitate entry of the helicopter bucket into the containers. The bucket guides may also serve to cover the open tops of the containers while they are being transported. The water transfer system can be part of a larger ground-based system which is providing fire suppression in the same area using a series of adapters to make connections between lengths of water transfer conduit. The technologies described herein provide solutions to various problems associated with operation of the inventive firefighting installations. The solutions provide enhanced safety features for helicopter pilots and ground-based crews as well as generally improving the working environment of the aerial firefighting installations during operations, and the capability to return excess pumped water back to the original water source and depart the site of the installation upon completion of operations with very little impact to the environment.

Various embodiments will now be described with reference to the FIGS. The embodiments take many different forms. These embodiments are provided so that this disclosure will be thorough and complete, and will fully convey the scope of the systems, deployment processes and methods to those skilled in the art.

For the purposes of illustration, in the Figures where scale bars are indicated, efforts are made to show features approximately at scale to facilitate understanding of the operation of the systems described herein. In other Figures, components and ranges are not necessarily drawn to scale, as will become apparent from context. In such cases, emphasis is placed on highlighting the various contributions of the components to the functionality of various embodiments. A number of possible alternative features are introduced during the course of this description. It is to be understood that, according to the knowledge and judgment of persons skilled in the art, such alternative features may be substituted in various combinations to arrive at different embodiments.

In describing the Figures, similar reference numbers are used to refer to similar elements wherever possible. In the Figures, the thickness of certain lines, layers, components, elements or features may be exaggerated for clarity.

The terminology used herein is for the purpose of describing particular embodiments and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Well-known functions or constructions may not be described in detail for brevity and/or clarity. Spatially relative terms, such as “under”, “below”, “lower”, “over”, “upper” and the like, may be used herein for ease of description to describe one element or feature's relationship to another element(s) or feature(s) as illustrated in the Figures. It will be understood that the spatially relative terms are intended to encompass different orientations of the device in use or operation in addition to the orientation depicted in the Figures. For example, if a device in the Figures is inverted, elements described as “under” or “beneath” other elements or features would then be oriented “over” the other elements or features. Thus, the exemplary term “under” can encompass both an orientation of over and under. The device may be otherwise oriented (rotated 90 or at other orientations) and the spatially relative descriptors used herein interpreted accordingly.

Similarly, the terms “upwardly”, “downwardly”, “vertical”, “horizontal” and the like are used herein for the purpose of explanation only unless specifically indicated otherwise. The terms “upstream” and “downstream” may be used in this description to indicate the direction of physical fluid flow. In context of water flowing through a conduit as a result of pressure from a pump, the term “downstream” refers to the direction away from the pump. In context of flow of water via a natural water course such as a river, “downstream” refers to the direction of the current as driven by gravity from an elevated position to a position of lower elevation.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present.

It will be understood that, although the terms “first”, “second”, etc. may be used herein to describe various elements, components, etc., these elements, components, etc. should not be limited by these terms. These terms are only used to distinguish one element, component, etc. from another element, component. Thus, a “first” element, or component discussed below could also be termed a “second” element or component without departing from the teachings herein. In addition, the sequence of operations (or steps) is not limited to the order presented in the claims or FIG. s unless specifically indicated otherwise.

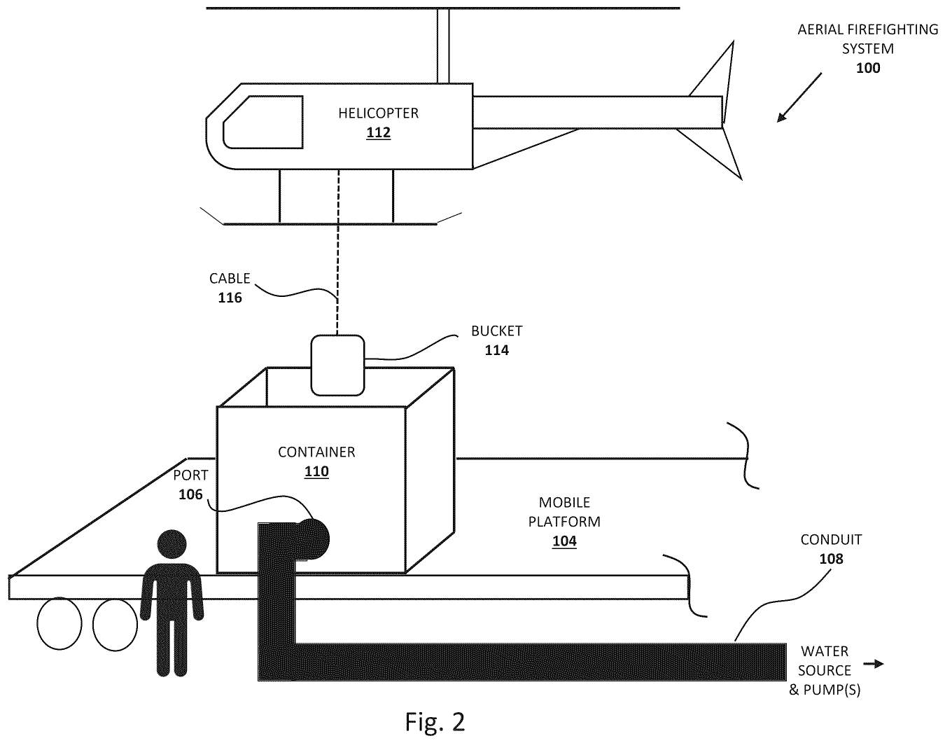

FIG. 2 illustrates one embodiment of an aerial firefighting system 100 which includes a container 110 carried on a mobile platform 104. In this particular embodiment, the container 110 is one of a number of standard shipping container sizes conventionally known as a “10-foot” shipping container which has external dimensions of about 3.0 m (L)×about 2.4 m (W)×about 2.6 m (H) providing an internal volume of about 16 m³ (16,000 L). As described in more detail below, alternative embodiments may use larger shipping containers, which may be provided with internal dividers to form compartments. The present inventors have discovered that a standard 10-foot shipping container provides an excellent balance between volume and height available for dipping a bucket 114 carried on a cable 116 by a helicopter 112, as well as being a commonly available class of shipping container. One of the main advantages of the embodiments of systems and installations described herein is that they employ commonly used equipment which may be conveniently modified or retrofitted with additional components and features to provide useful functionality at reduced cost relative to production of specialized equipment and devices. If an effort to fight a major remote fire at short notice is received and several firefighting installations must be assembled, it is possible to source shipping containers and rapidly retrofit them or use them in combination with relatively simple accessory devices and transport them for use in embodiments of the firefighting installations described herein.

In the embodiment of FIG. 2, the mobile platform 104 is a conventional flat-bed trailer. A port 106 is formed in the container 110, which is preferably located at a height which is reachable by a person standing on the ground next to the trailer, so that a water transfer conduit 108 can be manually connected to the port 106 by that person without requiring a ladder. In some embodiments, the port 106 is located adjacent to the bottom of the container 110 such that the center of the port 106 is about 170 cm to about 190 cm above the ground surface when the container 110 is on the mobile platform 104 to facilitate connection of the conduit 108 without using a ladder. In some embodiments, the free end of the conduit 108 is provided with a quick connect fitting (not shown) and the port 106 is provided with a complementary quick connect fitting (not shown) to facilitate the connection without requiring specialized tools. The filling ports 106 may be provided by cutting a suitable opening in the containers and welding fittings such as quick-connect fittings to the edges of the openings. In some embodiments a pipe is welded to the circumference of the opening and the quick connect fitting is welded to the outer end of the pipe to provide an outwardly extending quick connect fitting. Such features are particularly helpful in dangerous fire situations where the firefighting installation must be assembled and operated rapidly. In certain preferred embodiments, the quick connect fitting on the port 106 is configured to accept a complementary fitting installed on a conduit having a diameter of at least about 5 inches, at least about 8 inches, or at least about 10 inches in order to preserve compatibility with conduit dimensions used for ground-based fire suppression systems which may be used in combination with the aerial firefighting installations described herein.

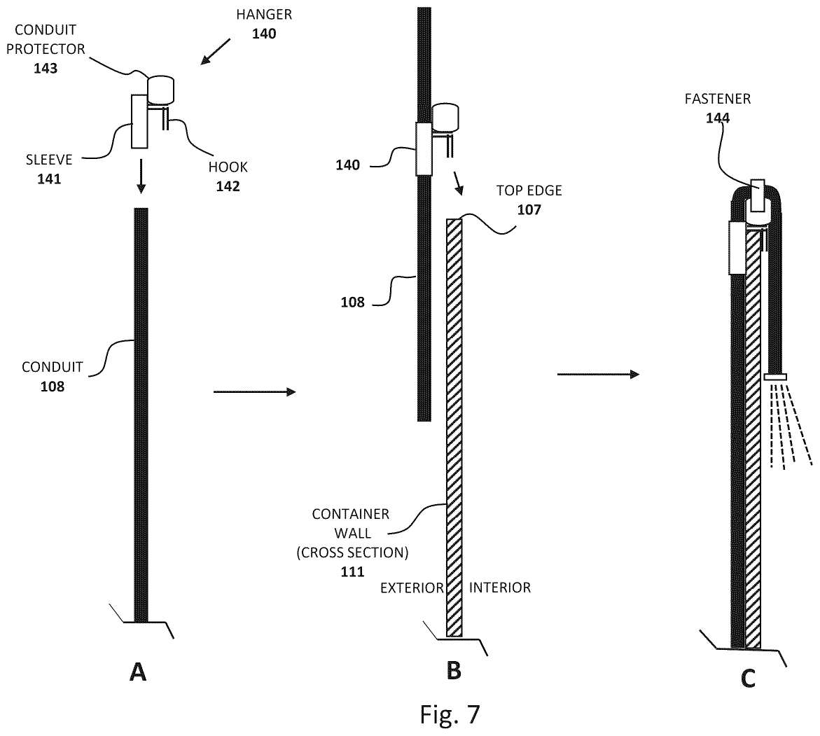

In some embodiments, a port 106 is not formed in the container 110 and instead, the open end of the conduit 108 is pulled up along the outer wall of the container 110 and dropped into the open top of the container 110. While this arrangement may be adopted in certain situations when a firefighting effort must be undertaken immediately and a container with a port 106 is not available, it is expected to be accompanied by the disadvantage of being less secure and reliable than using a container 110 with a port 106. To address this disadvantage, a customized hanger tool 140 may be used to secure the conduit 108 to the top edge of the container as illustrated in FIG. 7 where section A shows a conduit 108 arranged vertically to indicate how the hanger 140 is formed of a sleeve 141 connected to a hook 142. In some embodiments, the sleeve 141 may be split along its length and fastenable to form a continuous sleeve to facilitate its installation on the outer sidewall of the conduit 108. A conduit protector 143 may be connected to the hook 142 or to the sleeve 141 to provide a smooth radiused surface which protects the conduit 108 from being punctured or otherwise damaged by sharp edges at the top of the side wall 107 of the container 111. Once the hanger 140 is installed on the conduit 108, the resulting assembly can be hung by the hook 142 on the top edge 107 of the container wall 111. Section B of FIG. 7 shows placement of the hanger 140 at the top edge of the container wall 111 and Section C shows how the conduit can be pulled over the conduit protector 143 of the hanger and pulled down along the inner sidewall to ensure that water conveyed through the conduit 108 is directed down toward the bottom of the container. An additional fastener 144 may be provided to hold the conduit in place over the protector 143. If deemed appropriate following testing, the conduit protector 143 may be provided as a pulley wheel to reduce friction on the conduit 108.

Consideration of the choice between forming ports in the containers as shown in FIG. 2 or hanging the conduits on the top edge 107 of the container wall 111 as shown in FIG. 7 should consider the advantages and disadvantages of each arrangement. In constructing ports near the bottom of the containers, the disadvantage lies in the extra metal work required to cut holes and weld connectors such as quick connect fittings. However, once this step is complete, the process of assembling a shipping container-based firefighting installation is made much more convenient. On the other hand, if rapid deployment of a shipping-container based firefighting installation is required and suitable containers with ports and quick connect fittings are not immediately available, it is advantageous to have the option of hanging a conduit on the top edge of a container wall of a newly sourced container using a hanger device such as the basic hanger device 140 illustrated in FIG. 7, even though it would likely require cooperation between at least two workers to pull the conduit up over the upper edge of the container and secure it in that location using the hanger 140.

In some embodiments, the conduit 108 is lay flat hose typically formed of reinforced polymer such as thermoplastic polyurethane, which is convenient for rapid deployment from spools using vehicles such as trucks, skid steers or all-terrain vehicles. Advantageously the spools of lay flat hose are provided in lengths ranging between about 150 m and about 250 m. In some embodiments, it is advantageous to use consistent lengths of 200 m, for example, so that workers can be attuned to the lengths during the deployment process. A length of about 200 m provides a good balance between spacing between joints and the mass and diameter of the spools used for deployment. The use of larger diameter hoses is advantageous in providing the capability to transfer large volumes of water rapidly over large distances, thereby providing flexibility in selection of appropriate firefighting installation locations. In some embodiments, water may be transferred over distances of several kilometers using these larger diameter hoses. An appropriate pumping pressure ranges may be provided by inclusion of additional in-line pumps within the main water transfer conduit to ensure that the containers are filled rapidly and reliably with water available for helicopter bucket-based firefighting operations. Advantageously, pressure gauges are provided in communication with the water being transferred through the conduits so that a loss of pressure may be identified and addressed by provision of additional in-line pumping capacity.

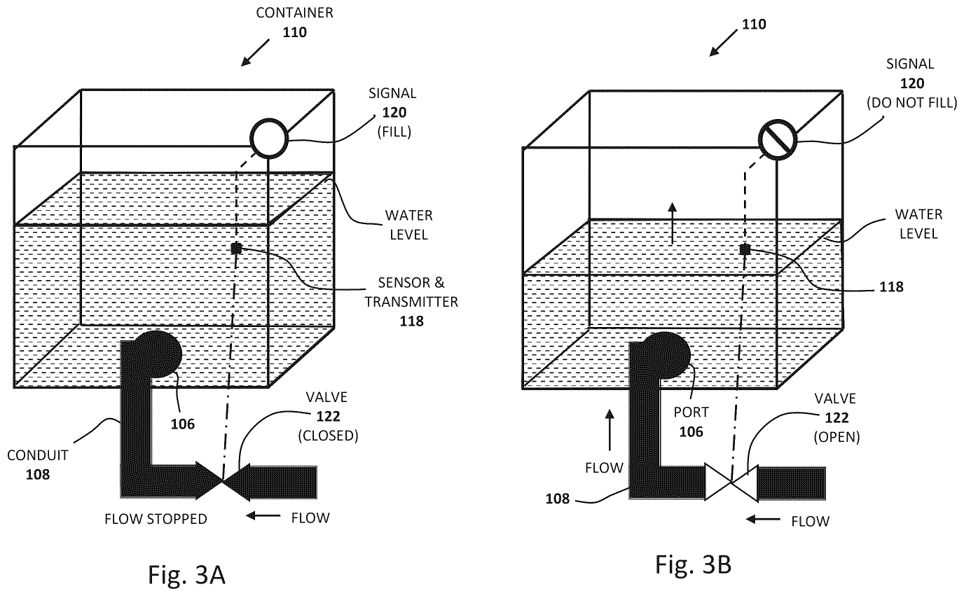

Turning now to FIGS. 3A and 3B, there is shown a mechanism for sensing the water level in the container 110, which is shown in a transparent view. This mechanism is provided as part of an effort to automate the container-based firefighting installation. The mechanism uses a sensor and transmitter 118 mounted to an interior wall of the container 110. In FIG. 3A, the water level is just above the sensor and transmitter 118. As the container 110 is filled and the water level reaches the sensor and transmitter 118, a signal is sent to close a valve 112 in the conduit 118, thereby preventing additional filling of the container 110. An appropriate level of filling which is convenient for bucket filling operations may be determined by experimentation with the buckets intended for use at the aerial firefighting installation. The status is indicated by a signal 120 which is visible to a helicopter pilot approaching the installation. The signal 120 of FIG. 3A informs the pilot that the container 110 has sufficient water for filling the bucket. The state of the signal is automatically changed according to sensing of the water level and transmission of a signal from the sensor and transmitter 118.

In FIG. 3B, it is seen that the water level has dropped below the level of the sensor and transmitter 118 as a result of water being withdrawn from the container 110 by the helicopter (not shown). At this point, the transmitter sends a signal to open the valve 112, causing water to flow from the conduit 108 into the container 110 to raise the water level, as indicated by the arrow within the container 110. The signal 120 informs the helicopter pilot that the container 110 is not ready to accept the bucket. The signal 120 will remain in this state until sufficient water has been pumped into the container 110 so that the water level reaches the sensor and transmitter 118 (the state shown in FIG. 3A), at which time the signal 120 will switch to indicate that the container 110 has sufficient water for filling the bucket.

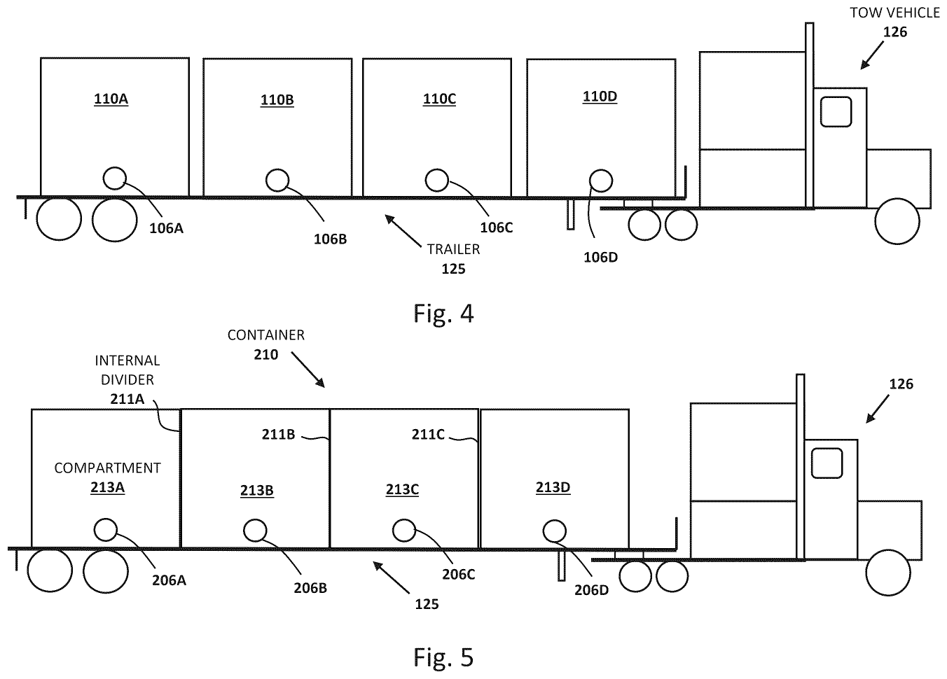

The present inventors have recognized that the enhanced efficiency provided by a system based on 10-foot containers which allow the helicopter(s) to return more quickly to the installation will make it necessary to provide firefighting installations with a series of containers to accommodate rapid filling for helicopter bucket operations. Therefore, it was realized that four 10-foot containers 110A-D could be transported reliably on a single conventional 53-foot flatbed trailer as shown in FIG. 4, which conventionally has general dimensions of about 16.2 m (L)×about 2.6 m (W)×about 1.5 m (H). Since helicopter bucket filling operations are precise enough to use dip tanks (as illustrated in FIG. 1), a helicopter pilot can select one of the four 10-foot containers on a stationary flat-bed trailer 125 to fill the bucket. Each of the containers 110A-D includes a filling port 106A-D.

In an alternative embodiment, a conventional 40-foot container 210 may be used as shown in FIG. 5. A conventional 40-foot container has typical dimensions of about 12.0 m (L)×about 2.4 m (W)×about 2.6 m (H) and an internal volume of about 64 m³. The container 210 includes three internal dividers 211A-C, which divide the interior volume of the container 210 into four compartments 213A-D such that the volumes of each compartment are generally similar to those of the conventional 10-foot containers shown in FIG. 4 (about 16 m³). It is to be understood that for this particular embodiment, each one of the four containers 110A-D of FIG. 4 and each one of the four compartments 213A-D, is provided with a corresponding filling port 206A-D. While it is recognized that there is a disadvantage in the time required to retrofit a 40-foot container with internal dividers 211A-C to form the compartments 213A-D, the option to do so may be helpful if containers are required at short notice for deployment of a firefighting installation and only 40-foot containers are available.

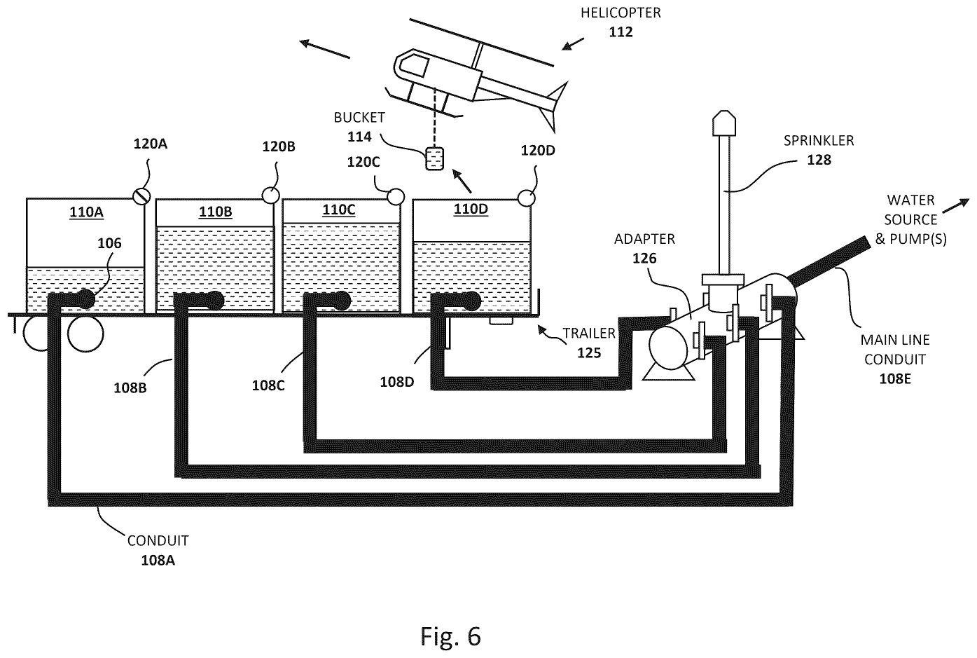

Turning now to FIG. 6, there is shown one basic embodiment of a firefighting installation which includes a water transfer network. This embodiment illustrates the use of four 10-foot containers 110A-D. It is to be understood that the same principles will apply to alternative containers such as the 40-foot container 210 of FIG. 5, with internal dividers 211A-C to form four compartments 213A-D. This embodiment illustrates containers with ports 106 but can also be arranged without ports by hanging the conduits over the top edges of the containers with or without the conduit hangers illustrated in FIG. 7. In the embodiment illustrated in FIG. 6, the conduits 108A-D extend from the ports 106 to an adapter 126 which receives water from a main line conduit 108E which extends to a water source. In some embodiments, the main line conduit 108E extends over distances of less than a kilometer in length to several kilometers to reach a suitable water source. In-line pumps (not shown) may be provided at connection points between lengths of conduit at suitable intervals (for example about 600 m intervals) to maintain sufficient pressure to fill the containers 110A-D at a suitable rate to ensure that helicopter pilots are not required to wait for the containers to have suitable water levels to fill the buckets. In FIG. 6 it is shown that containers 110B-C have sufficient water levels and that the helicopter 112 has just finished filling its bucket 114 from container 110D. Container 110A has a low water level and as a result, its signal 120A indicates “do not fill” (circle with sloped line) so that the pilot is informed that container 110A is not available while the other signals 120B-D indicate that containers 110B-D are available. The adapter 126 includes three lateral branch points on each side and an upper branch point to which is connected a sprinkler 128.

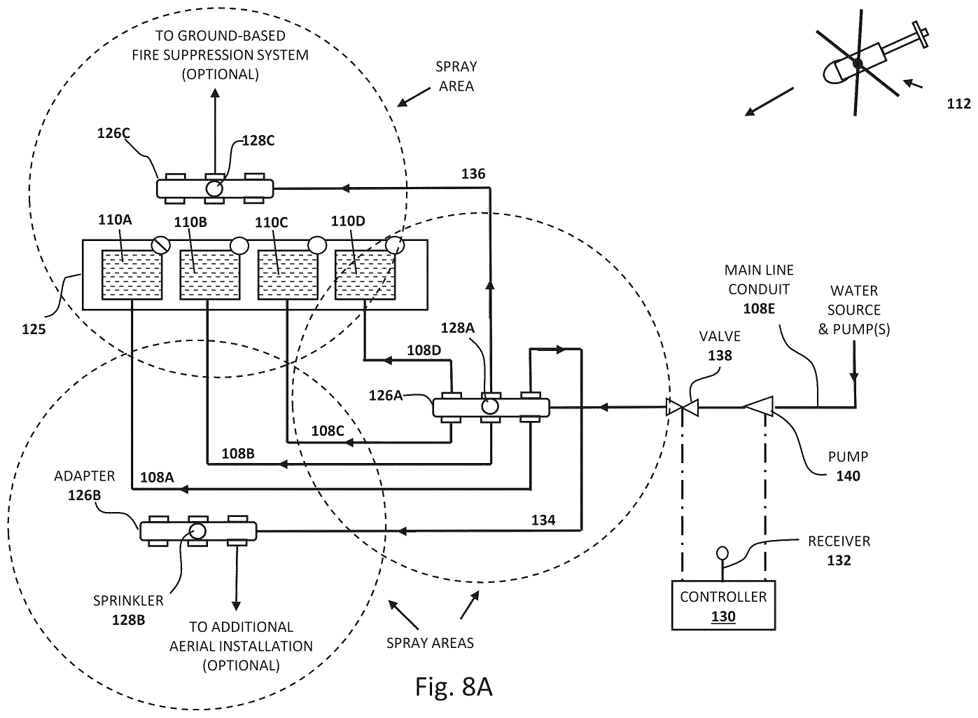

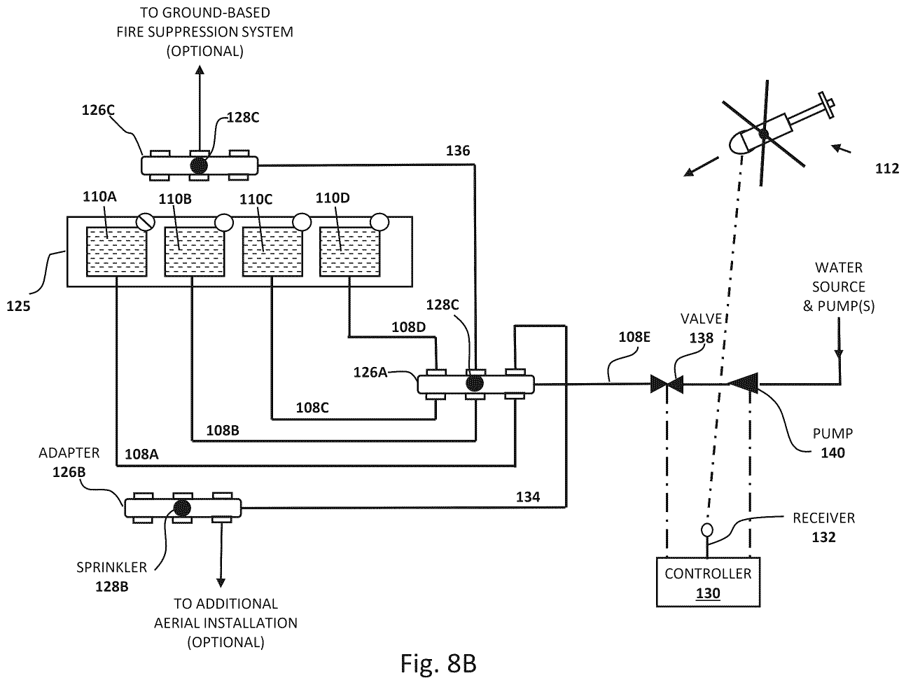

Turning now to FIGS. 8A and 8B, there is shown an aerial plan view of an expanded version of the installation shown in FIG. 6 which illustrates additional adaptable functionality and safety features benefitting helicopter pilots and workers on the ground. The installation of FIGS. 8A and 8B has four containers 110A-D supported on a trailer 125 and could also operate with a single larger container such as the container 210 of FIG. 5. As in FIG. 6, the four conduits 108A-D extend from corresponding containers 110A-D to a centrally located adapter 126A which has a sprinkler 128A connected thereto. Adapter 126A receives water from main conduit line 108E which may include a series of in-line pumps suitably spaced from each other to maintain pressure in the main conduit line 108E. One such pump 140 is illustrated in FIGS. 8A and 8B.

Adapter 126A is used to provide a branch line 134 to adapter 126B with sprinkler 128B and another branch line 136 to adapter 126C with sprinkler 126C. The three adapter-mounted sprinklers 128A-C are operated to spray water into the air to create three generally circular spray areas shown in dashed lines in FIG. 8A. It is advantageous to provide a dampened area at the firefighting installation because wildfire operations are usually performed during dry weather conditions and the rotor downwash from helicopters filling buckets at the installation cause significant quantities of dust to be dispersed around the area, which is undesirable and potentially dangerous for the helicopter pilots and workers on the ground. The dampened area around the installation reduces this dust problem. In most embodiments, the sprinklers 128A-C will operate as long as the containers 110A-D are being filled. It is also undesirable to have the sprinklers 128A-C operating and the containers 110A-D being filled when a helicopter 112 is preparing to fill its bucket because a sudden unexpected upward spray of water from the sprinklers 128A-C could cause a distraction to the pilot and also because filling the containers 110A-D will cause turbulence in the containers 110A-D which could complicate the bucket filling operations. There is also potential for failures to occur at connection points of the water transfer network which could lead to sudden spraying of water at high pressures and this could lead to an accident involving the helicopter 112. Therefore, an automatic safety feature is provided in this installation to stop flow of water to the adapters 126A-C and containers 110A-D. It is shown in FIG. 8B that when the helicopter 112 reaches a threshold distance from a receiver 132 at the installation (for example detection of a beacon on the helicopter 112), a signal is triggered by controller 130 to shut off the pump 140 and close a valve 138 in conduit 108E. These two automatic operations stop the sprinklers 128A-C and also stop flow of water into the containers 110A-D so that the helicopter 112 can fill its bucket without any interference from flowing or sprayed water. The absence of the dashed circles in FIG. 8B indicating spray areas shows that that the sprinklers 128A-C are not operating. The controller 130 will maintain the system in a shut-down state until the receiver 132 no longer detects the presence of the helicopter 112 after it leaves the installation area to continue firefighting operations. Once the helicopter 112 is no longer detected by the receiver 132, the controller 130 opens the valve 138 and re-starts the pump 140 for filling the containers 110A-D and operating the sprinklers 128A-C as illustrated in FIG. 8A.

The installations shown in FIGS. 6, 8A and 8B include adapters 126, 126A-C for making connections between lengths of conduit and provide flexibility to the system by permitting branch connections to be made to provide additional branch conduits for various purposes such as sprinklers (which may be adapter-mounted sprinklers, or separate sprinklers operated at branch lines) for dampening the installation area, providing additional water transfer lines for additional ground-based fire suppression efforts or branch lines to serve additional installations located nearby or at significant distances (as described below, with reference to a hypothetical deployment example). The adapters may be provided with various features to enhance their flexibility and functionality. However, it is advantageous to at least provide the adapters with a series of connection points configured to facilitate connection of conduits and to provide branch line connection points. The number of branch line connection points may be variable, depending on the desired characteristics of the system. Example embodiments of such adapters are commonly owned by the present applicant and described, for example in Canadian patent 3,093,478, which is hereby incorporated herein by reference in its entirety.

The adapter embodiments described below are particularly useful in being able to operate efficiently in the aerial firefighting installations described herein, as well as ground-based fire suppression systems described in Canadian patent 3,093,478. This adaptability permits a combination of a ground-based fire-suppression system and the present aerial firefighting installation to be operated from the same main water source. An example of such a combination will be discussed in detail below.

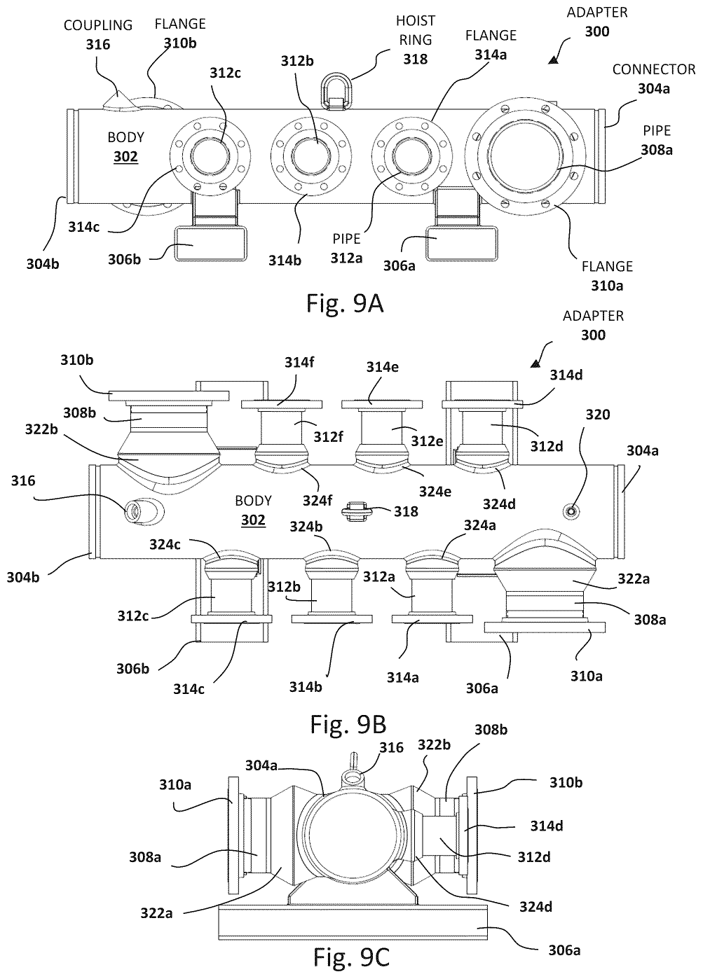

One embodiment of an adapter 300, constructed with features to facilitate implementation of various embodiments of the fire suppression system is described with respect to different views in FIGS. 9A to 9C. A description of the functions of the adapter will be described following a description of its structural features. FIG. 9A is a side elevation view of this embodiment of the adapter 300 which has a cylindrical main hollow body 302 provided with connector ends 304a,b for connecting to end couplings of large diameters of mainline conduit such as 10-inch (25 cm) diameter lay flat hose, for example.

It is advantageous to have the main body 302 of the adapter elevated above the ground to facilitate connections of branch lines. Therefore, the body 302 is connected to a pair of mounting members 306a,b. In the side elevation view of FIG. 9A, it can be seen that one large diameter pipe 308a extends laterally outward from the body 302 on the right side in this view. This large diameter pipe 308a is outwardly connected to a large diameter flange 310a to provide a point of connection to another line. There is also a large diameter pipe 308b and corresponding large diameter flange 310b on the opposite side of the body 302 near its left end as best seen in the top view of FIG. 4B. In FIG. 4A, it is seen that three additional smaller diameter pipes 312a-c with similar diameters extend laterally outward from the body 302. These pipes 312a-c are also connected outwardly to smaller diameter flanges 314a-c. Likewise, there are also three similar pipes 312d-f on the opposite side of the body 302 as best seen in the top view of FIG. 9B. In this view, it is seen that a top coupling port 316 near the left end of the adapter 300 is provided to provide flow communication at the top of the adapter 300 which could be used for a number of applications, including mixing of fire-retardant components.

Additionally, a hoist ring 318 is located substantially centrally at the top of the adapter 300 to facilitate hoisting and transfer of the adapter 300.

FIG. 9B is a top view of the adapter 300 which provides additional clarification of the arrangement of components. It is more clearly seen that the two large diameter pipes 308a,b and corresponding flanges 310a,b are connected adjacent to the opposed connector ends 304a,b to provide the adapter with 2-fold lateral rotational symmetry to provide balance to the center of gravity of the adapter 300 (when an axis passing through the hoist ring 318 toward the bottom of the body 302 is rotated, pipe 308a will move to the position of pipe 308b with a 180 degree rotation. This balanced center of gravity provides stability to the adapter 300. These large diameter pipes 308a,b are integrated with the body 302 via corresponding joints 322a-b. Similar arrangements are provided with the six similar small diameter pipes 312a-f, corresponding flanges 314a-f, and joints 324a-f connected to the body 302. Also seen in FIG. 4B is the top coupling 316, the hoist ring 318 and a second coupling 320 adjacent connector end 304a.

FIG. 9c is a View From the Front End Corresponding to the Right Side of FIG. 9b.

In FIG. 9C, it is seen that the large diameter pipe 308a, flange 310a and corresponding joint 322a are on the left side and smaller diameter pipe 312d, corresponding flange 314d and joint 324d are on the right side. Behind the smaller diameter pipe 312d, corresponding flange 314d and joint 324d is the second large diameter pipe 308b, corresponding flange 310b and joint 322b.

The adapter 300 is a versatile and robust device for use in various embodiments of the fire suppression process and system described herein. A total of 8 connection points are provided, each of which can be provided with valves to control or shut off flow therefrom. Two connection points are larger and may be suitable for providing two or more additional main line extensions. The remaining connection points have smaller diameters and are suitable for creating branch lines and/or gap-filling lines for attachment of water dispensing devices or for other applications such as filling additional water tanks of various sizes which may be carried by vehicles used in active firefighting efforts.

Individual firefighting hoses or lines extending to other water dispensing devices or pumps may also be connected to the adapter 300 via one of the smaller diameter flanges 314a-f.

As noted briefly above, the top coupling port 316 can be used to attach a line to a container of a fire-retardant mixture suitable for mixing with water. In operation, the fire-retardant mixture (a commercially available fire-retardant mixture such as, for example, Phos-Check™, a mixture of phosphate and sulfate salts which prevents combustion of cellulosic material, together with thickening agents) enters the adapter 300 at the coupling port 316 and is mixed by the rapid flow of water through the adapter body 302.

Other pipes such as pipes 312a-f, for example, could also be used for mixing of a fire-retardant mixture.

In one example embodiment, the adapter body 302 has a total length of about 60 inches (152 cm) and an inner diameter of about 10 inches (25 cm). In this embodiment, the base length of each mounting member 306a,b is about 30 inches (76 cm). The inner diameter of the large diameter pipes is about 8 inches (20 cm) and the inner diameter of the small diameter pipes is about 4 inches (10 cm). The total height of the adapter from the bottom of the mounting members 306a,b to the top of the body 302 is about 17 inches (43 cm). Other adapter embodiments will have different dimensions. Other adapter embodiments have two, three, four, five, six or seven or more than eight pipes. In some alternative embodiments all pipes have the same dimensions. In other alternative embodiments the pipes have three or more different sized diameters.

Embodiments having a plurality of connection points are also commonly referred to as “manifolds.”

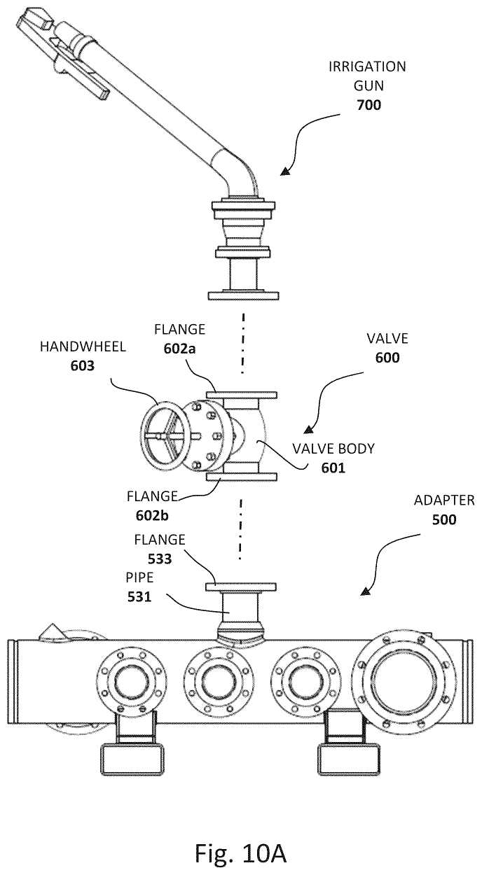

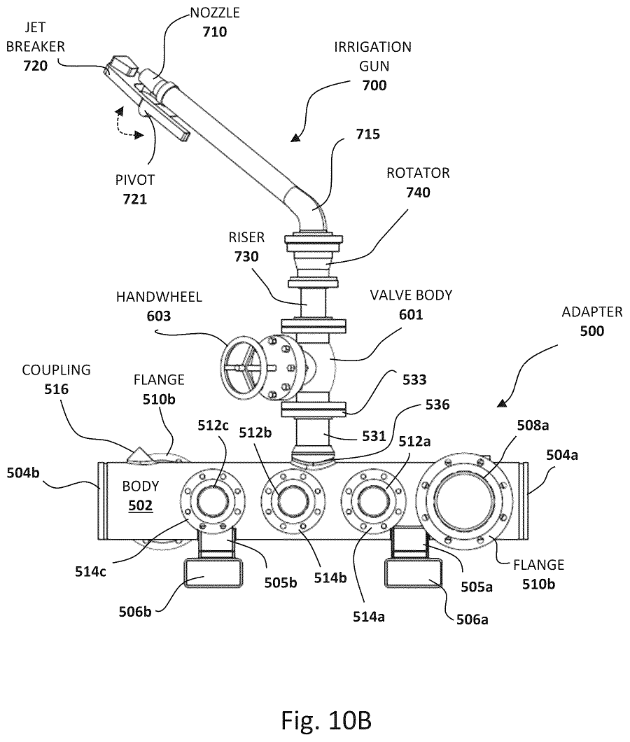

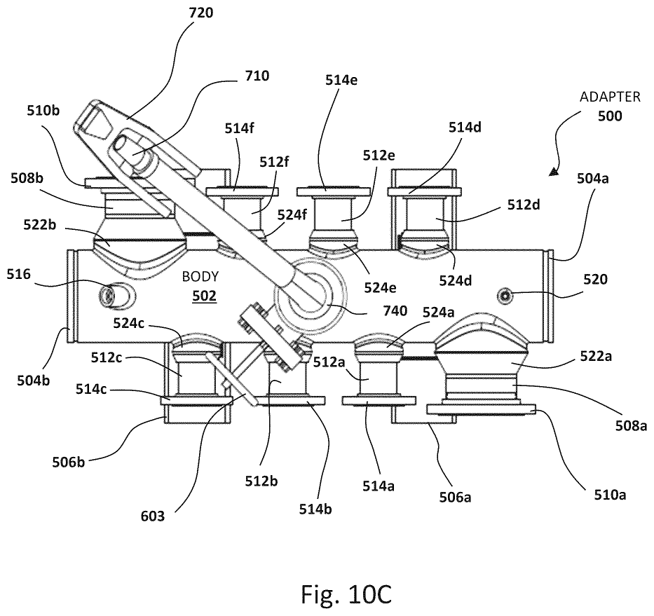

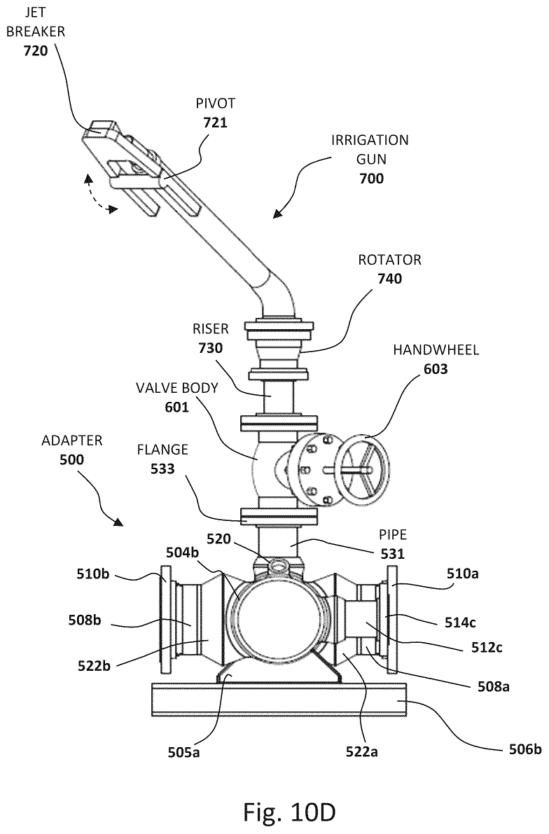

Another adapter embodiment 500 is described with respect to FIGS. 10A to 10D which has features providing for attachment of a water dispensing device known as an irrigation gun. Irrigation guns have been developed primarily for agriculture applications and are capable of spraying large jets of water at high pressures over relatively large distances. Water jet-producing devices with capabilities similar to irrigation guns are known as water cannons. Water cannons have been primarily developed for marine firefighting and riot control applications. Incorporation of irrigation guns into ground-based fire suppression systems is described in incorporated Canadian Patent 3,093,478 as a result of recognition that the proportions of the originally designed adapter embodiment developed to prevent it from becoming destabilized (as large volumes of water delivered by the large diameter conduit pass therethrough), would also provide sufficient stability to mount and operate an irrigation gun, thereby obviating the need for a separate mounting system for the irrigation gun. As described above for adapter embodiment 300, adapter embodiment 500 also acts as a connector of mainline conduit segments in construction of a longer mainline conduit and thus allows the full pressure of the mainline conduit to be expelled from the irrigation gun. This arrangement has other advantages which will be described in more detail hereinbelow.

Turning now to FIG. 10A, there is shown an exploded view of an arrangement of an irrigation gun 700 connected to a valve 600 and adapter 500. The valve 600 includes a valve body 601 terminating in connector flanges 602a,b and a handwheel 603 for operating the valve 600 to open or close water flow from the adapter 500 to the irrigation gun 700. This adapter embodiment 500 is modified with respect to the previously described adapter 300 by having a pipe 531 connected to the body 502 with a joint 536 and flange 533 extending vertically upward from the upper surface of the adapter body 502. Advantageously, the pipe 531 has sufficient height to provide space for handwheel 603 above the body 502 of the adapter 500, thereby avoiding the possibility of interference of operation of the handwheel 603 with other valve handwheels (not shown) which would be coupled to flanges 512b and 512c in the view shown, for example, or other valve controlling mechanism which may be coupled to any of the flanges 510a,b, 512a,d-f if the handwheel 603 is oriented in any other direction with respect to the vertical axis of the pipe 533. The flange 533 is provided for connection of the valve 600 via flange 602b to the irrigation gun 700 as shown in additional views in FIGS. 10B to 10D.

It is seen in FIG. 10B, showing a side elevation view of the assembly which includes the adapter 500, valve 600 and irrigation gun 700 that the irrigation gun 700 includes a riser 730 and an upper rotator 740 which is adjustable to permit 360 rotation of the irrigation gun 700 as well as restricting the rotation between any desired fraction of 360 degree rotation by providing limits on the rotation to concentrate a more restricted dampened area for asset protection, for example. The riser 730 may be of variable height, provided that stability of the assembly is maintained. This particular irrigation gun 700 has an elbow 715 to provide the irrigation gun 700 with a water jet axis at approximately 33 elevation from horizontal. One irrigation gun embodiment is provided with a mechanism for changing the water jet angle. Angles between about 15 to about 45 from horizontal may be useful in various situations if obstacles are to be avoided in generating a dampened area for fire suppression. Larger angles up to 90 (vertical) may be helpful in other situations, such as a need to avoid higher obstacles while ensuring that water is dispersed high into the air.

The irrigation gun shown in FIGS. 10A to 10D has a nozzle 710. The nozzle 710 may be replaced to provide water jets of various diameters, for example between about 0.71 inches (1.8 cm) to about 1.5 inches (3.8 cm). Additionally, in this arrangement, the irrigation gun 700 includes an optional jet breaker 720 mounted near the nozzle on a pivot 721. The jet breaker 720 is biased towards alignment with the direction of the water jet.

When the water jet strikes the jet breaker 720, the water jet is dispersed when it contacts the jet breaker 720 and the jet breaker 720 is forced downward to generate a short period wherein the water jet is not dispersed. The biasing force then returns the jet breaker 720 to the water jet blocking position to cause dispersal of water. In some embodiments, this jet-breaking cycle continues at intervals in the range of about 0.5 to about 2 seconds to generate alternating dispersion and uninterrupted water jets to cause the water sprayed from the irrigation gun 700 to cover a larger area, as desired for fire suppression.

It is advantageous to mount a pressure gauge (not shown) on the irrigation gun 700 to provide a pressure readout of water passing through the irrigation gun 700. The pressure gauge will conveniently indicate to operators if a pressure drop has occurred due to some problem in any of the mainline equipment downstream of the irrigation gun 700.

Advantageously, the pipe 531 is located substantially centrally on the adapter 500 to maintain an appropriate center of gravity to ensure sufficient balance of the weight of the components connected thereto at the flange 533.

Other than the features described hereinabove, the adapter shown in FIGS. 10A to 10D has features similar to those of the first described adapter embodiment 300 of FIGS. 9A to 9C, including hose connector end outlets 504a,b, larger diameter laterally extending joints 522a,b, pipes 508a,b and flanges 510a,b for connection of up to two larger diameter branch line hoses (not shown) and smaller diameter laterally extending joints 524a-f, pipes 512a-f and flanges 514a-f for connection of up to six smaller diameter branch line hoses (not shown). Advantageously, during deployment of a branch line hose, a handwheel-operated valve similar to valve 600 is installed between a corresponding flange and hose in order to control flow of water from the adapter 500 to that hose. The body 502 of the adapter 500 also includes two upper surface coupling components 516 and 520 which may be used to inject fire retardant or other materials into the adapter 500 if desired.

Lastly, it is seen best in FIG. 10D that the adapter body 502 is supported on a pair of wide pedestals 505a,b each connected to a base 506a,b. Advantageously, the pedestals 505a,b are angled outward laterally from beneath the adapter body 502 such that the supporting width of each pedestal 505a,b is greater than the diameter of the adapter body 502. Each pedestal 505a,b is supported by and connected to a base 506a,b.

In this embodiment, the length of each base 506a,b is at least about equal to or longer than the width profile of the adapter 500 as defined by the distance between the laterally extending larger flanges 510a,b. Provision of this arrangement of pedestals 505a,b and bases 506a,b provides sufficient support to the adapter 500 to permit it to maintain sufficient stability, even when placed on uneven ground, as would be expected during deployment in rural areas or in the backcountry. Thus, this embodiment of the adapter 500 will have reliable stability and not require anchoring to the ground, thereby conserving deployment time. Provision of proper balance and stability is important because fire suppression efforts will be hindered even if a single adapter in a series becomes unbalanced and tips over during operation.

As mentioned briefly with respect to the previous adapter embodiment 300, the larger pipes 508a,b and connected flanges 510a,b are arranged at opposite ends of the body 502 in order to provide appropriate balance to the adapter 500. In this particular embodiment, the adapter by itself has D2 (2-fold) rotational symmetry about a vertical axis placed at the center of pipe 531. Absence of such symmetry to provide appropriate balance is unfavorable. For example, it is to be understood that if pipes 508a,b and flanges 510a,b were each located closer to one end of the body 502, the center of gravity of the adapter would be displaced from a mid-point along the body, causing instability.

This adapter embodiment 500 provides a number of advantages. In one aspect, the adapter has significant flexibility provided by eight lateral pipes to extend branch lines or main line lateral extensions. These laterally extending pipes are elevated significantly above the ground by the pedestals and bases to facilitate connection of end caps or valves for controlling flow into or out of laterally extending branch lines or main lines. The mass of the adapter, which can range between about 800 pounds (362 kg) to about 1000 pounds (453 kg) provides it with significant stability to support an irrigation gun and permit water flow at high pressures without tipping over.

Adapter 500 can be deployed and operated more rapidly than adapter 300 which lacks an upper pipe arrangement for mounting of an irrigation gun. Fire suppression systems described herein which have adapters lacking this feature require lateral deployment of branch conduits outward from the laterally extending adapter pipes. If a fire suppression system must be deployed and activated rapidly to fight an encroaching fire, an assembly which includes one or more adapters 500 would permit an irrigation gun 700 or other water dispensing device to be mounted directly to the adapter 500 without a need to connect and deploy a hose to feed the water dispensing device. Branch line conduit deployment (which extends laterally from the adapter) is expected to represent a significant amount of total deployment time. In addition, direct mounting of an irrigation gun 700 to the adapter 500 allows lateral conduits to be connected and to extend further outward from the adapter 500. The irrigation gun 700 attached to the adapter 500 can provide a dampened area closer to the adapter 500 itself, in case the lateral conduits are deployed to distances where attached water dispensing devices cannot dispense water from their deployed locations back as far as the adapter 500. Furthermore, the irrigation gun 700 may be attached to the adapter 500 prior to transport and deployment. This conserves time in deployment, allowing deployment workers to focus on connecting segments of main line, deploying branch lines, if required, and other tasks associated with operation of the installation.

In one example, a firefighting installation is being deployed in an emergency helicopter firefighting effort using adapters of embodiment 500 with previously connected irrigation guns 700. These irrigation guns 700 thus can immediately provide a generally circular dampened area around the adapters 500. While this dampened area is being generated, significant fire protection is provided to the workers while lateral branch line conduits are attached to and deployed from the adapter 500 and connected to containers for filling helicopter buckets or connected to smaller water dispensing devices to further extend the dampened area outward from the range of the irrigation guns 700. One group of workers can then focus on extending the main line while another group of workers can focus on deploying the branch lines from each adapter 500. If desired, following deployment of branch lines from a given adapter 500, the valve 600 can be closed using the handwheel 603 and the irrigation gun 700 and associated components shown in FIGS. 10A to 10D can be removed from the adapter 500 with the knowledge that a dampened area continues to be generated using the newly assembled branch lines extending from the adapter 500. Thus, the adapter 500 and irrigation gun 700 assembly formed by taking advantage of the described features of the adapter provides significant flexibility in operation of the assembly and the firefighting installation.

Without limiting the scope of the embodiments herein, some selected dimensions of the adapter embodiment 500 will now be described in an effort to outline selected features. It is to be understood that these dimensions and features may be modified. This adapter 500 (known informally to deployment workers as the “10-inch manifold”) has a total mass of about 920 pounds (417 kg), a main body 502 length of 60 inches (152 cm) and a main body 502 inner diameter of 10 inches (25 cm). The upper pipe 533 and the smaller lateral pipes 512a-f each have a length of 6 inches (15 cm) and an inner diameter of 3.2 inches (8 cm) each with an NPS 4 class 300 threadolet used as joints 536 and 524a-f. The flanges 533 and 514a-f of the smaller pipes 533 and 512a-f are ANSI RF threaded NPS 4 class 150 flanges. The larger lateral pipes 508a,b each have a length of 4 inches (10 cm) and an inner diameter of 8 inches (20 cm), each with an NPS 8 XS weldolet used as joints 522a,b. The flanges 510a,b of these pipes 508a,b are ANSI RF threaded NPS 8 class 150 flanges. The two bases 506a,b are 30 inches (76 cm) long, 4 inches (10 cm) high and 8 inches (20 cm) wide and are provided to support pedestals 505a,b which are 14 inches (35 cm) long, and 4 inches (10 cm) high with a curved upper surface to match the outer diameter of the body 502 of the adapter 500 for connection thereto. The bases 506a,b are located about 16 inches (40 cm) from the outer ends of the body 502. It has been that the adapter 500 having these selected dimensions provides excellent stability during deployment and operation such that a separate anchoring system is not required, thereby simplifying deployment and operation. However, as noted above, departures from these dimensions are possible, provided that suitable stability and functionality is retained.

In one alternative embodiment, all dimensions are similar except that the inner diameter of the body 502 is about 12 inches (30 cm) and the pedestals 505a,b have suitable matching upper curvature. This alternative embodiment has a mass of about 975 pounds (442 kg). This alternative embodiment of adapter 500 is known informally to deployment workers as the “12-inch manifold.” This alternative embodiment is expected to be useful in situations where a 12-inch (30 cm) diameter lay flat hose is used in a fire suppression system to deliver greater volumes of water than the previously described adapter embodiment.

Another alternative embodiment has similar dimensions except that the inner diameter of the body 502 is about 8 inches (20 cm) and the pedestals 505a,b have suitable matching upper curvature. This alternative embodiment has a mass of about 865 lbs. (392 kg).

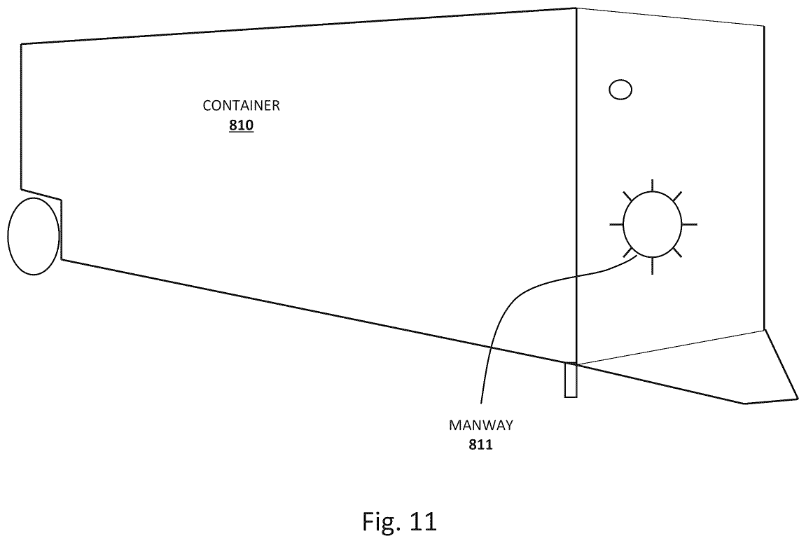

Turning now to FIGS. 11 to 18, there is shown another embodiment of a container 810 suitable for helicopter bucket filling operations. This container 810 is based on modification of an existing type of conventional container used in oilfield operations, which is known as a “liquid storage tank” or “frac tank.” Such tanks may have various sizes generally ranging from about 8,400 gallons (about 38 m³) to about 21,000 gallons (about 100 m³) and typically include one or more sets of axles and wheels and are connectable to a tow vehicle so that they are not required to be lifted onto flatbed trailers. Due to the mass of the contained liquids a frac tank may be provided with integral hydraulic lifts to lower the bottom of the tank to the ground and raise the axle and wheel set to reduce the strain on these components when the tank is stationary at a site of operations. Conventional frac tanks often include a scaffold arrangement to permit workers to gain access to the top surface of the tank. The scaffold is usually installed at the front of the tank, adjacent to the point of connection to a tow vehicle. Some applications of frac tanks include, but are not limited to, storage and transport of large amounts of industrial liquids and proppants, mixing of various liquids using coupled pumps, and separations of mixtures using filters.

An example of a frac tank used as the basis for modification to provide a container adapted for helicopter bucket filling operations is known in the market as the “Dragon Model 500 Barrel Corrugated Wall Liquid Storage Tank” manufactured by Dragon Products Ltd. of Bowmont, TX, USA (dragonproductsltd. com) which has a capacity of about 500 BBL (about 79.5 m³) of liquid. Other embodiments may be based on other examples of oilfield liquid storage tanks.

These conventional liquid storage tanks may have various features suited to various applications such as various ports, manifolds and valves. A frac tank will typically include a large port close to ground level which is sufficiently large to permit entry of a worker into the interior of the tank. This type of port is conventionally known as a “manway.” In the current example embodiment, a manway is retrofitted for use as the main port for filling the container 810, as outlined in more detail below. However, it is to be understood that certain embodiments of the inventive container may be manufactured to include the features described herein, instead of being retrofitted from existing liquid storage tanks.

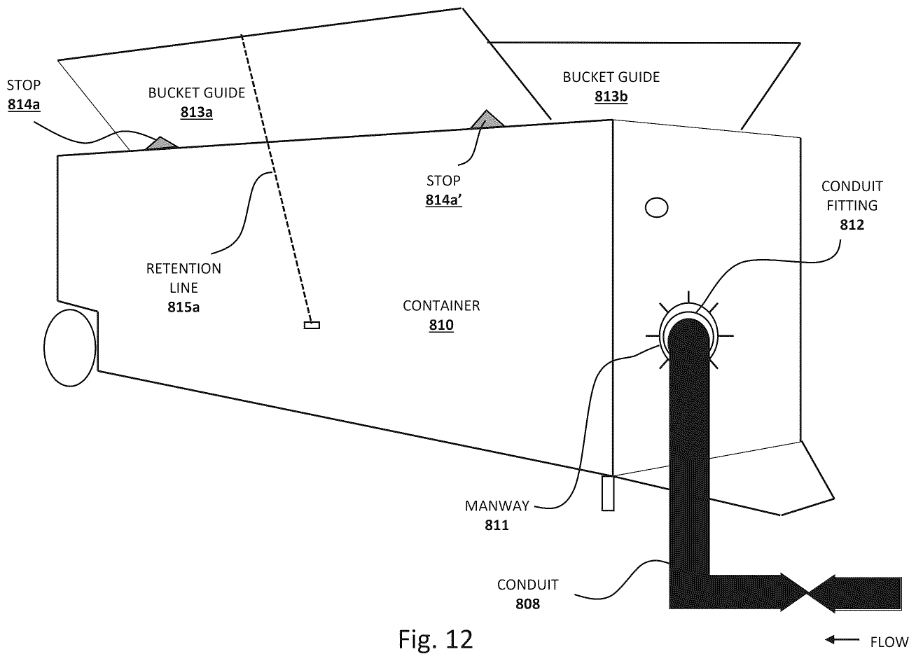

As noted above, container embodiment 810 is based on a retrofitted liquid storage tank to include a series of modifications. As shown in FIG. 11, the container 810 includes a manway 811. FIG. 12 shows additional features including a conduit fitting 812 mounted to the manway 811 which permits connection of a conduit 808. In certain preferred embodiments, the conduit 808 is formed of lay flat hose having a diameter of at least about 8 inches (about 20 cm). In alternative embodiments, the conduit 808 may be connected to other ports or manifolds which may exist prior to modification or retrofitting of a liquid storage tank to provide a container suitable for bucket filling operations.

In providing a filling port having a diameter of at least about 8 inches (about 20 cm), the container 810 can be filled rapidly. According to an example calculation, an embodiment of container 810 having a capacity of about 500 BBL (about 79.5 m³), being filled via a modified manway port using lay flat hose with a diameter of about 8 inches (about 20 cm) at a typical rate of 22 m³/min using available pumps, the container 810 can be completely filled in under 4 minutes, thereby providing useful functionality for firefighting efforts.

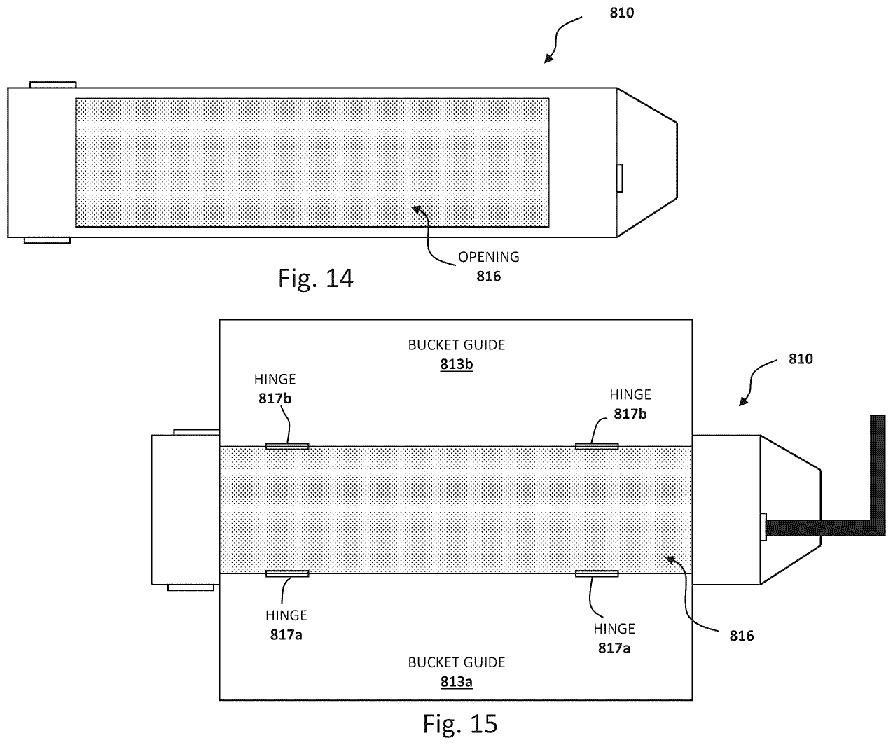

FIG. 12 illustrates another view of container 810 which shows certain retrofit modifications of a commercial version of a liquid storage tank. While not visible in the view of FIG. 12, container 810 has a rectangular opening in its upper surface. In the top view of FIG. 14, it can be seen that the opening 816 is a rectangular opening spanning a majority portion of the upper surface of the container 810. It was surprisingly discovered that while it is advantageous to provide a wide opening area to provide a large bucket drop target to facilitate bucket filling operations, extending the opening 816 too close to the front and back of the container 810 will compromise the structural integrity of the container 810, as indicating by movement of the sidewalls of the container during filling or during transport of water. It was surprisingly discovered that the structural integrity of the container may be advantageously retained by limiting the length of the opening 816 to no more than about 75% of the length of the top surface of the container 810. In some embodiments, the top surface of the container 810 has a length of about 40 feet (about 12.2 m) and a width of about 8.5 feet (about 2.6 m) and the opening is approximately centered on the top surface and has a length of about 27 feet (about 8.2 m) and a width of about 7 feet (about 2.1 m). In this case, the opening represents about 67.5% of the original surface area of the upper surface of the container 810 before the opening was provided. However, it is reasonably predicted that the opening could be extended to cover up to about 75% of the surface area of the upper surface of the container 810.

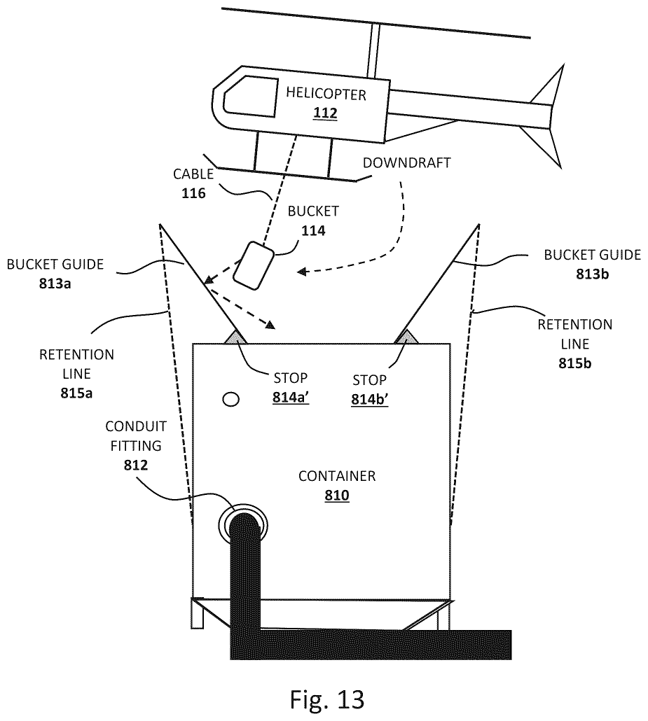

Referring to FIGS. 12 to 18, it is seen that a pair of bucket guides 813a,b in the form of elongated panels are pivotally mounted to the longitudinal edges of the opening 816. With reference to FIG. 13, it can be seen that when the bucket guides 813a,b are deployed, they are angled to form a funnel shape to facilitate entry of the bucket 114 into the container 810. This feature was developed because initial testing indicated that when a bucket carried by a helicopter approaches an open top container filled with water, the resulting downdraft interference generates air currents close to the container which causes the bucket to swing laterally as shown in FIG. 13. This requires the helicopter pilot to maneuver to ensure that the bucket 114 reaches the opening 816. The bucket guides 813a,b limit the swinging of the bucket 114 and their angled arrangement induces downward movement of the bucket 114 into the container 810 via the opening 816, thereby reducing the delay and requirement for maneuvering caused by the swinging bucket 114.

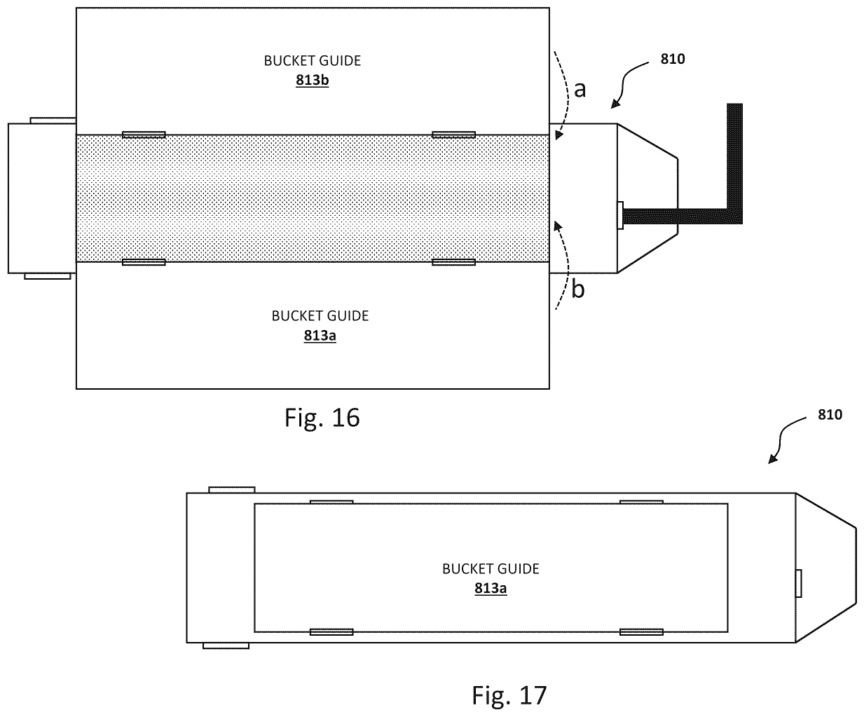

FIG. 15 shows that the bucket guides 813a,b are pivotally mounted to edges of the opening 816 by hinges 817a,b. In FIG. 15 the bucket guides 813a,b are deployed so that they are parallel with the upper surface of the container 810, in order to show that they each have a width to generally match the width of the opening 816 (however, in their properly deployed positions, they are angled upwards as shown in FIGS. 12 and 13). With this width dimension, the bucket guides 813a,b can act to cover the opening 816 while the container 810 is being transported or when the container 810 is stationary and helicopter bucket operations are suspended. When deployed in their functional angled positions, the bucket guides 813a,b have sufficient height to effectively guide the bucket 114 into the opening 816. In the sequence shown with the curved dashed arrows in FIG. 16 to provide the closed positions, bucket guide 813b first pivots on its hinges 817a,b to cover the opening 816 and then bucket guide 813a pivots on its hinges 817a,b to rest on top of bucket guide 813b to attain the arrangement illustrated in FIG. 17.

Returning now to FIGS. 12 and 13, in contrast to the fully extended bucket guides 813a,b shown in FIGS. 15 and 16, it is seen that the extension of the bucket guides 813a,b is limited by stops 814a,b mounted to the upper surface of the container 810. The stops 814a,b are sloped to ensure that, for each bucket guide 813a,b a suitable angle is formed between the plane of the upper surface of the container 810 and the plane of the bucket guide 813a,b. In preferred embodiments, this angle is from about 110° to about 130° with respect to the top surface of the container 810 such that the two deployed bucket guides 813a,b form a suitable funnel shape to induce a swinging bucket to enter the opening 816 in the container 810.

It is also seen in FIGS. 12 and 13 that the container 810 is provided with a mechanism to retain the bucket guides 813a,b in their deployed functional positions. One embodiment of this retention mechanism is provided by retention lines 815a,b, each fixed to an upper edge of each bucket guide 813a,b which is tensioned and fixed to a conveniently reachable connection point at a side wall position of the container 810. The retention lines 815a,b provide tension on the bucket guides 813a,b to prevent them from being dislodged away from their deployed open positions when impacted by the expected helicopter downdraft.

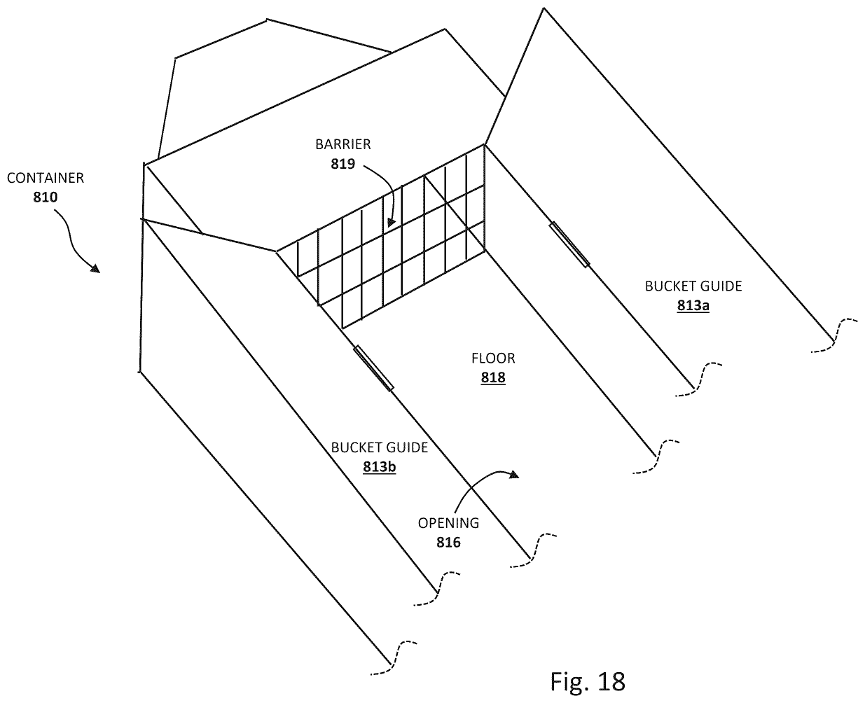

FIG. 18 is an upper perspective view of the container 810 with the bucket guides 813a,b deployed to expose the opening 816. The inventors recognized that when a bucket is lowered into the opening, it would be possible for the bucket to drift within the contained water and become stuck within the front end or back end of the container 810 beneath the upper surface of the container 810 because of the limited rectangular opening 816 and that this could cause a safety issue for the helicopter pilot or a delay in operations. Thus, as a result of having an upper opening extending across no more than about 75% of the upper surface, a new problem has developed. To prevent this problem from occurring, a vertical barrier 819 is provided to extend from the top surface of the container 810 to the floor of the container 810 at both the front and back of the opening 816. FIG. 18 illustrates a water permeable barrier 819 in the form of a screen at the front end of the opening 816. A similar screen-based barrier is provided at the back of the opening (not shown). A rigid screen is a convenient barrier which allows water to flow efficiently throughout the interior of the container 810, while preventing a bucket from moving into the space beneath the upper surface of the container 810. Other arrangements of vertical barriers may also be provided to prevent a bucket from moving beneath the top surfaces of the container 810 at the front and back of the container 810.

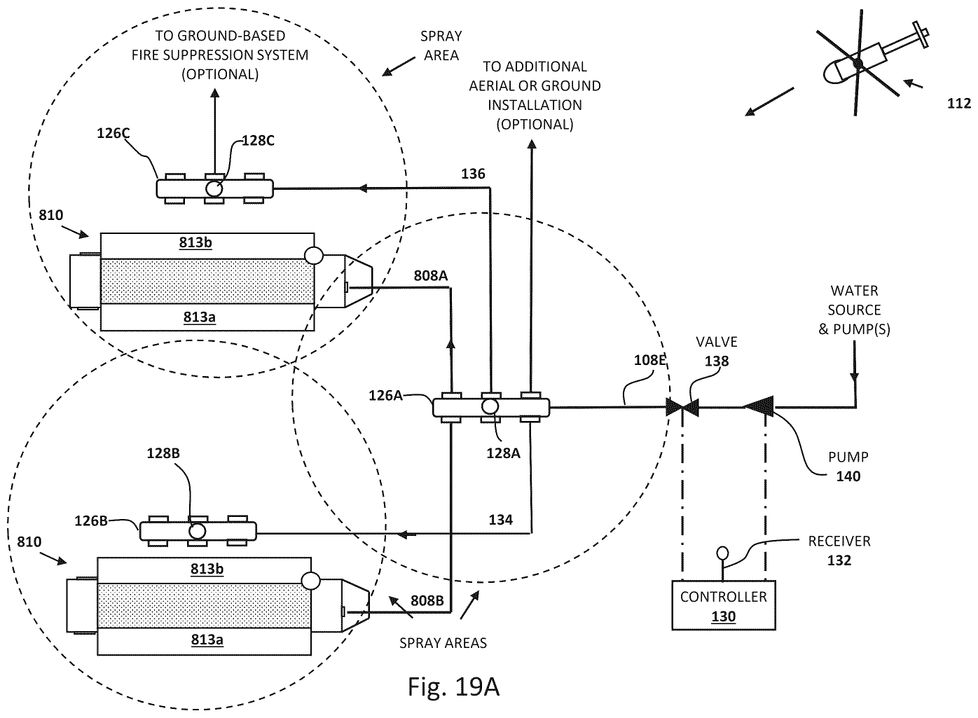

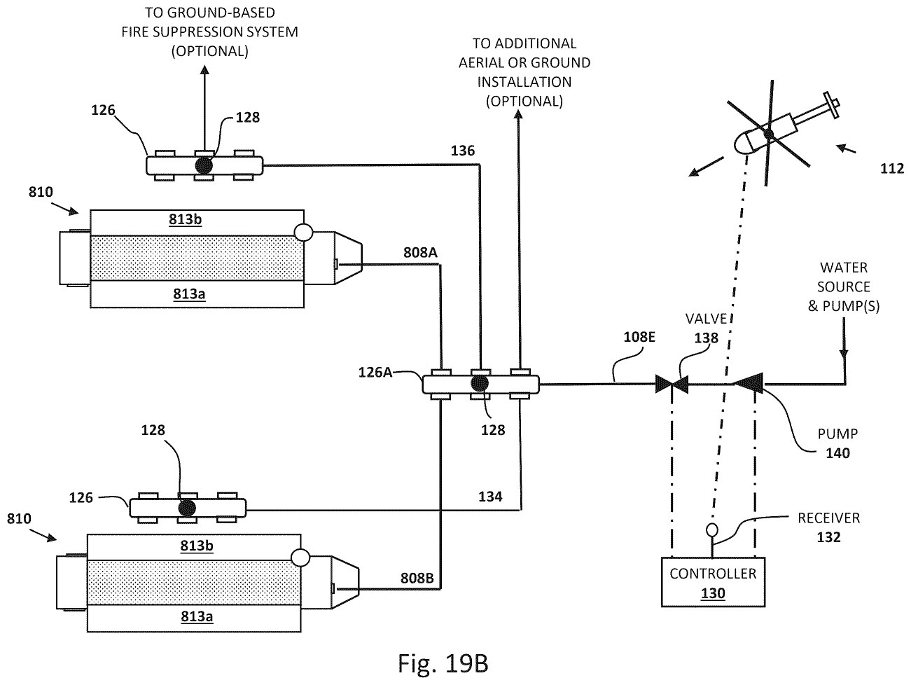

FIGS. 19A and 19B illustrate an aerial view of a versatile firefighting installation which uses container embodiment 810 with additional equipment described previously with respect to FIGS. 8A and 8B. In this example installation embodiment of FIGS. 19A and 19B, there are two containers 810 receiving water pumped from a water source by pump 140 via conduit 108E which extends to an adapter 126A. Adapter 126A splits the flow and sends it to two separate containers 810 via conduits 808A and 808B. Adapter 126A also sends water to two additional adapters 126B and 126C which are provided primarily to spray water via sprinklers 128B and 128C mounted to the adapters 126B and 126C. Adapter 126A also has a sprinkler 128A for this purpose. The sprinklers 128A-C wet the area of the installation to prevent excessive dust from being raised by the approach of the helicopter 112. Excessive dust is undesirable and potentially dangerous for the helicopter pilots and workers on the ground. Adapter 126A also shows an optional conduit that can be used to extend water service to an additional aerial or ground-based firefighting installation. It is to be understood that such optional conduits may also be provided via adapters 126B and 126C to provide an expanded network of linked aerial or ground-based firefighting or fire suppression installations.

In most embodiments, the sprinklers 128A-C will operate as long as the containers 810 are being filled. However, it is undesirable to have the sprinklers 128A-C operating and the containers 110A-D being filled when a helicopter 112 is preparing to fill its bucket because a sudden unexpected upward spray of water from the sprinklers 128A-C could cause a distraction to the pilot and also because filling the containers 810 will cause turbulence in the containers 110A-D which could complicate the bucket filling operations. There is also potential for failures to occur at connection points of the water transfer network which could lead to sudden spraying of water at high pressures and this could lead to an accident involving the helicopter 112. Therefore, an automatic safety feature is provided in this installation to stop flow of water to the adapters 126A-C and containers 810. It is shown in FIG. 19B that when the helicopter 112 reaches a threshold distance from a receiver 132 at the installation (for example detection of a beacon on the helicopter 112), a signal is triggered by controller 130 to shut off the pump 140 and close a valve 138 in conduit 108E. These two automatic operations stop the sprinklers 128A-C and also stop flow of water into the containers 810 so that the helicopter 112 can fill its bucket without any interference from flowing or sprayed water. The absence of the dashed circles in FIG. 19B indicating spray areas shows that that the sprinklers 128A-C are not operating. The controller 130 will maintain the system in a shut-down state until the receiver 132 no longer detects the presence of the helicopter 112 after it leaves the installation area to continue firefighting operations. Once the helicopter 112 is no longer detected by the receiver 132, the controller 130 opens the valve 138 and re-starts the pump 140 for filling the containers 810 and operating the sprinklers 128A-C as illustrated in FIG. 19A.

The installations shown in FIG. 19A and B include adapters 126A-C for making connections between lengths of conduit and provide flexibility to the system by permitting branch connections to be made to provide additional branch conduits for various purposes such as sprinklers (which may be adapter-mounted sprinklers, or separate sprinklers operated at branch lines) for dampening the installation area, providing additional water transfer lines for additional ground-based fire suppression efforts or branch lines to serve additional installations located nearby or at significant distances (as described below, with reference to a hypothetical deployment example). The adapters may be provided with various features to enhance their flexibility and functionality. However, it is advantageous to at least provide the adapters with a series of connection points configured to facilitate connection of conduits and to provide branch line connection points. The number of branch line connection points may be varied, depending on the desired characteristics of the system. Example embodiments of such adapters are commonly owned by the present applicant and have been described herein and in Canadian patent 3,093,478, which is incorporated herein by reference in its entirety. The adapter embodiments 300 and 500 described herein with reference to FIGS. 9 and 10 are particularly useful in being able to operate efficiently in the aerial firefighting installations described herein, as well as in combinations with ground-based fire suppression systems described in incorporated Canadian patent 3,093,478. This adaptability permits a combination of a ground-based fire-suppression system and the present aerial firefighting installation to be operated from the same main water source. An example of such a combination will be discussed in detail below.

### EXAMPLE 1

### Deployment of an Aerial Firefighting Installation

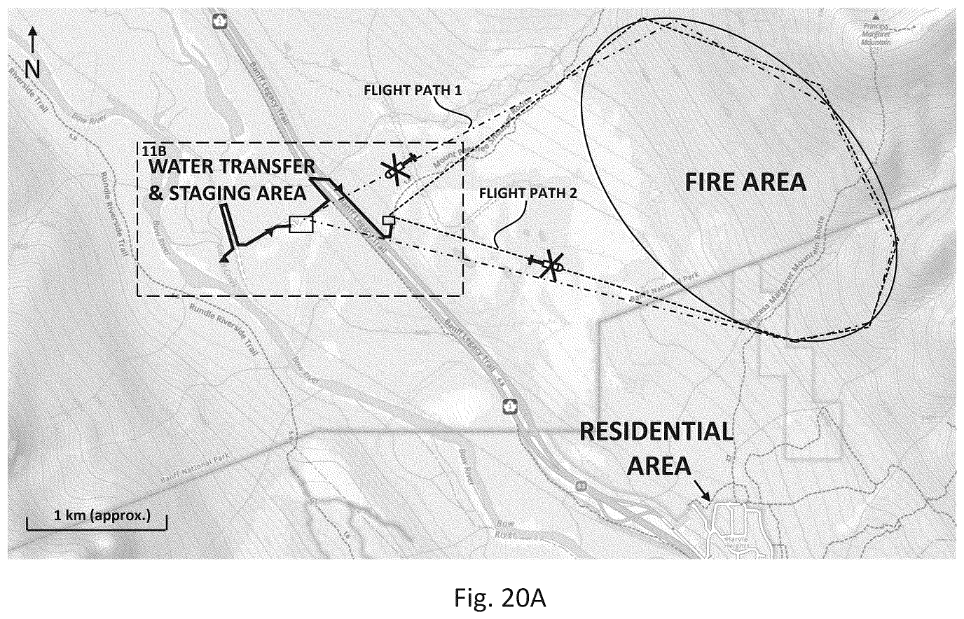

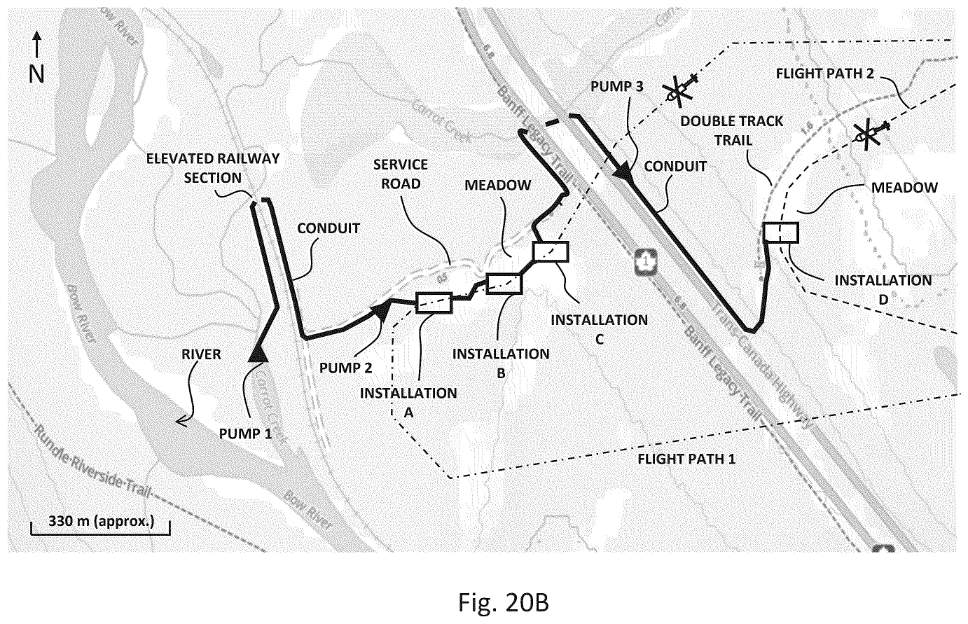

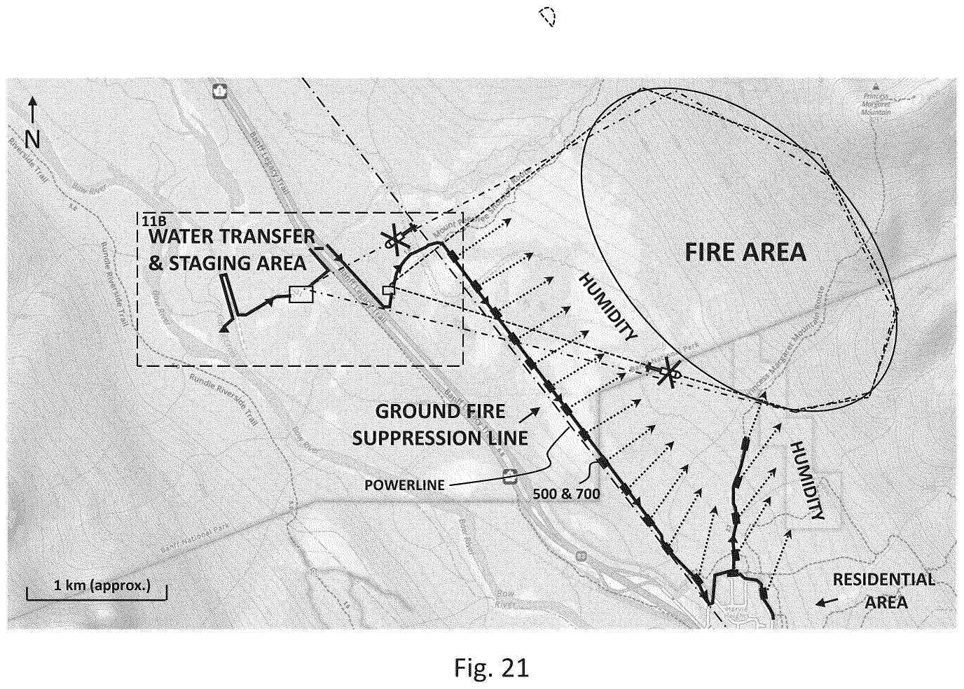

This hypothetical example describes how an aerial firefighting installation could be designed and deployed to fight a fire on a mountain slope which is in close proximity to a residential area. FIG. 20A shows a map of the vicinity of the main southeastern boundary of Banff National Park where Highway 1 enters the park. A wildfire driven by dry westerly summer winds is in progress on a mountain slope north of a residential area. The Bow River shown extending from the top left corner towards the middle bottom of the map is in a high flow condition which is not suitable for conventional helicopter bucket-filling operations. The Carrot Creek tributary is also not suited for conventional bucket-filling operations due to insufficient depth. For the purpose of illustrating the advantages of the aerial firefighting installation, this hypothetical example assumes that the closest suitable candidate body of water for conventional helicopter bucket-filling operations is Lake Minnewanka, a large body of water located within Banff National Park about 13 km north of the fire site (this lake is not shown in FIGS. 20 and 21). A helicopter flight to this lake from the fire site requires flight over a mountain range for a round trip of at least about 26 km.

This situation is recognized as suitable for deployment of an embodiment of a series of aerial firefighting installations to support firefighting operations. As illustrated in FIG. 20A, the Bow River is identified as a suitable water source for water transfer through a flexible conduit having a diameter of at least about 8 inches and formed of lay flat hose. Locations for staging of mobile containers, such as container embodiments 810, are identified in small meadows located on both sides of Highway 1 inside the national park boundary which are identified with small rectangles inside a larger dashed rectangle indicated as the water transfer and staging area. This area is magnified by about 3.3× in FIG. 20B to show more detail. FIG. 20A shows examples of complete flight paths for two helicopters filling buckets at the installations (see installations A-D in FIG. 20B). It is to be understood that the flight paths would vary according to the intensity of the fire at various locations in the fire area, in order to drop water from buckets on those locations. One helicopter fills its bucket at the larger western installation network via flight path 1 and the other helicopter fills its bucket at the smaller eastern installation which is closer to the fire via flight path 2.

Turning now to FIG. 20B, which shows an approximate 3.3× magnification of the water transfer and staging area to illustrate additional detail, it is seen that analysis of the geographical and constructed features of the area led to the recognition that the western installation could be rapidly deployed in a clearing south of a forest service road which extends to a railway track closer to the Bow River. The railway track has an elevated section passing over the main tributary of Carrot Creek. This is recognized as a suitable location to deploy the main water transfer conduit to a wider point of Carrot Creek before it enters the Bow River.

FIG. 20B also shows that the western portion of the staging area includes three separate installations A-C. In this particular example, each installation A-C (and also installation D) is generally similar to the installations shown in FIGS. 19A and 19B, with mobile containers 810 provided with bucket guides 813a,b. Installation D is deployed on the east side of Highway 1 in a meadow which is accessible via a double-track trail. The conduit extends generally north from the initial pump at Carrot Creek, extends beneath the elevated section of the railway track, and then extends south and then east along the forest service road east of the railway track where a second pump is installed prior to the conduit transferring water to installations A, B and C.

While the detailed network of conduits providing water to the containers 810 at each installation is not shown to preserve clarity, it is to be understood that an available branch point of an adapter servicing installation A is used to connect a segment of conduit and send water to installation B and an adapter servicing installation B has a branch point which is used to send water to installation C. Likewise, an adapter servicing installation C is used to generate another segment of water transfer line following the service road towards Highway 1 and then turning northwest adjacent to the eastbound lanes of Highway 1. This segment then is directed below the Highway 1 overpass above Carrot Creek to the east side, where it turns and runs southeast until it reaches a trailhead access road and turns north until it reaches a meadow and provides water to installation D. A third pump is provided in the conduit on the east side of Highway 1 to maintain suitable water pressure for installation D. It is more clearly illustrated in FIG. 20B that one helicopter has a flight path to perform bucket filling at any of installations A-C and the other helicopter has a flight path to perform bucket filling at installation D. If deemed appropriate and safe by aviation authorities, additional helicopters could be added to the firefighting effort and additional aerial firefighting installations could be deployed to expand the network of aerial firefighting installations.

As noted above, a conventional helicopter-based firefighting effort involving bucket filling flights to Lake Minnewanka from the site of the hypothetical fire illustrated on the map of FIG. 20A requires a round trip of about 26 km for each bucket of water. In contrast, deployment of the present example embodiment reduces this roundtrip distance to approximately 5 km, representing a significant reduction in flight time, which will lead to a significant cost savings for operating helicopters and increase the frequency of bucket dumping operations available before refueling. It is reasonably expected that in addition to the cost savings, deployment of aerial firefighting installations according to the example embodiments described herein will also increase the effectiveness of the firefighting efforts. In some embodiments, one or more temporary helicopter bases may be established near the aerial firefighting installations, which include mobile fuel tanks and other helicopter maintenance equipment to minimize the time that the helicopters are out of service during operations.

### EXAMPLE 2

### Combination of Aerial Firefighting and Ground-based Fire Suppression

FIGS. 20A and 20B indicate that the adapter 128C may optionally extend to a ground-based fire suppression system. An example of such an extension is illustrated in FIG. 21, which represents a modification to FIG. 20A shown at the same scale. In this hypothetical example, it is recognized by the firefighting authorities that the fire is likely to spread towards the residential area shown in the bottom right corner of the map of FIG. 21. It is decided to deploy a ground-based fire suppression system to protect the residential area and to spray large volumes of water into the air to increase the relative humidity of the area. The humid air generated by irrigation guns mounted on adapters installed along a main conduit extension is carried by the wind towards the fire, generating useful suppression of the fire.

In analyzing the geographical and infrastructure features of the area between installation D and the residential area, two candidate locations for the main conduit line of the ground-based fire suppression system are identified. A first candidate is the east shoulder of the westbound lanes of Highway 1. This is determined to be impractical because these lanes experience significant vehicular traffic and access to the shoulder is required by drivers wishing or needing to stop at or near the park gate. A powerline cut east of Highway 1 is identified as a suitable alternative. The powerline cut is a wide clearing for a major electrical transmission powerline which extends from nearby power generating facilities towards the residential area and is sufficiently wide and flat for service vehicles to carry and deploy the conduit and install adapters with irrigation guns and in-line pumps. An additional advantage of using the powerline cut is that there is sufficient space for the irrigation guns to aim sprays of water above the adjacent tree line so that the sprayed water can enter the air currents and be carried towards the fire area. This example shows 13 adapters 500 with mounted irrigation guns 700, indicated by black rectangles along approximately 3 km of the powerline cut. Additional inline pumps are indicated with black triangles. A branch line is shown as extending north from the residential area and including four adapters 500 and irrigation guns 700. The direction of spray is indicated with the dotted arrows, to indicate that significant relative humidity is generated and directed towards the fire area by the ground-based fire suppression system.

This example indicates the advantage of flexibility of the aerial firefighting installations described in Example 1, in being extendible to generate at least one ground-based fire suppression line. It is to be understood that the eight branch points provided by each adapter 500 may be closed off or opened up to create additional ground-based fire suppression lines or additional aerial firefighting installations, as well as providing other water service functions in filling other mobile ground-based water tanks, as described in Canadian patent 3,093,478.

### Equivalents and Scope

Other than described herein, or unless otherwise expressly specified, all of the numerical ranges, amounts, values and percentages, such as those for amounts of materials, elemental contents, times and temperatures, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Any patent, publication, internet site, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Unless otherwise defined, all technical and scientific terms used herein have the same meaning as commonly understood by one of ordinary skill in the art.

While the systems, deployment processes and methods have been particularly shown and described with references to embodiments thereof, it will be understood by those skilled in the art that various changes in form and details may be made therein without departing from the scope of the invention encompassed by the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context.

It is also noted that the term “comprising” is intended to be open and permits but does not require the inclusion of additional elements or steps. When the term “comprising” is used herein, the term “consisting of” is thus also encompassed and disclosed. Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. Where the term “about” is used, it is understood to reflect +1-10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein.

1. A mobile container configured for use in firefighting helicopter bucket filling operations, the container comprising:
a rectangular vessel having a flat upper surface and a rectangular upper opening with a length extending across no more than about 75% of the upper surface, the opening spaced apart from front and back ends of the vessel; and
front-and back-end barriers extending from front and back edges of the opening towards an interior bottom surface of the vessel, the barriers configured to permit passage of water to the front and back ends of the vessel while preventing the bucket from moving into front and back interior areas of the vessel when the bucket is dropped into the container via the opening.

2. The container of claim 1, wherein the vessel has a length of about 36 feet to about 40 feet and a width of about 8.5 feet and the upper opening is substantially centralized with respect to the upper surface and has a length of about 24 feet to about 27 feet and a width of about 6 feet to about 7 feet.

3. The container of claim 1, wherein the vessel includes a port having a diameter of at least about 8 inches, the port configured for attachment of a water transfer conduit having a diameter of at least about 8 inches.

4. The container of claim 3, which is retrofitted from a liquid storage tank including a manway, wherein the manway is modified to function as the port.

5. The container of claim 1, wherein the vessel is mounted on a frame with a wheel and axle set and a mechanism for connecting the container to a tow vehicle.

6. A firefighting installation for firefighting helicopter bucket filling operations, the installation comprising:
a container comprising a vessel having a flat upper surface and a rectangular upper opening with a length extending across a majority portion of the upper surface, the opening spaced apart from front and back ends of the vessel; and
a conduit extending from a water source, the conduit configured to transfer water to the container via a port in the container or, in the absence of the port, via the upper opening.

7. The firefighting installation of claim 6, wherein the majority portion is no more than about 75% of the length of the upper surface.

8. The firefighting installation of claim 6, wherein the vessel has a length of about 36 feet to about 40 feet and a width of about 8.5 feet and the upper opening is substantially centralized with respect to the upper surface and has a length of about 24 feet to about 27 feet and a width of about 6 feet to about 7 feet.

9. The firefighting installation of claim 6, further comprising front-and back-end barriers extending between the upper surface and an interior bottom surface of the vessel, the barriers configured to permit passage of water while preventing the bucket from extending into front and back interior areas of the vessel when the bucket is dropped into the container via the upper opening.

10. The firefighting installation of claim 6, wherein the port has a diameter of at least about 8 inches, the port configured for attachment of a water transfer conduit having a diameter of at least about 8 inches.

11. The firefighting installation of claim 10, wherein the container is retrofitted from a conventional mobile liquid storage tank including a manway, wherein the manway is modified to function as the port.

12. The firefighting installation of claim 6, wherein the vessel is mounted on a frame with a wheel and axle set and a mechanism for connecting the container to a tow vehicle.

13. The installation of claim 6, further comprising a water level sensor located inside the vessel, for sensing a specified water level sufficient for a helicopter bucket-filling operation to proceed, the sensor configured to provide a signal to the helicopter that either the specified water level has been reached and the bucket-filling operation may proceed, or that the water level has not been reached and the bucket-filling operation may not proceed.

14. The installation of claim 13, further comprising a transmitter in communication with a conduit valve for closing the conduit and preventing water flow into the vessel when the specified water level has been reached.

15. The installation of claim 6, further comprising an adapter connected to the conduit, the adapter including a plurality of branch point connectors for splitting the conduit into a network of conduits for optionally filling additional containers optionally included in the installation.

16. The installation of claim 6, wherein the flow of water to the containers is stopped as a safety feature when the helicopter reaches a threshold distance to the installation by a receiver sensing the presence of the helicopter, causing a controller to stop the flow of water to the containers.

17. The installation of claim 16, wherein the flow of water is stopped by the controller shutting a valve in the conduit or shutting off a pump controlling the flow of water.

18. The installation of claim 13, further comprising a first extension of the conduit to provide water to one or more additional mobile aerial firefighting installations.

19. The installation of claim 6, further comprising a second extension of the conduit to one or more ground-based fire suppression lines including a plurality of adapters, each having an irrigation gun mounted thereto.

20. The installation of claim 6, further comprising a series of in-line pumps in the conduit for maintaining water pressure at the port of the container of at least about 80 psi.
